(19) United States
(12) Patent Application Publication
(10) Pub. No.: US 2024/0270612 A1
(43) Pub. Date: Aug. 15, 2024

(54) SELECTIVE PRECIPITATION OF SOLUTES FROM AQUEOUS SOLUTIONS AND RELATED SYSTEMS

(71) Applicant: Battelle Energy Alliance, LLC, Idaho Falls, ID (US)

(72) Inventors: Caleb C. Stetson, Idaho Falls, ID (US); Hyeonseok Lee, Ammon, ID (US); Christopher J. Orme, Firth, ID (US); Daniel M. Ginosar, Idaho Falls, ID (US); Aaron D. Wilson, Idaho Falls, ID (US)

(21) Appl. No.: 18/567,344

(22) PCT Filed: Jun. 7, 2022
(86) PCT No.: PCT/US2022/072792

§ 371 Date: Dec. 5, 2023

Related U.S. Application Data
(60) Provisional application No. 63/202,324, filed on Jun. 7, 2021.

(51) Int. Cl. C02F 1/54; B01D 9/00; C02F 1/52; C02F 101/10; C02F 103/16; C22B 3/00; C22B 3/02; C22B 7/00; C22B 26/20; C22B 59/00

(52) U.S. Cl. CPC C02F 1/54; B01D 9/0036; B01D 9/004; B01D 9/0059; C22B 3/02; C22B 7/006; C22B 23/0461; C22B 26/20; C22B 59/00; B01D 2009/0086; C02F 2001/5218; C02F 2101/10; C02F 2103/16

(57) ABSTRACT

A method of removing one or more of solutes from an aqueous solution comprises introducing, into a first fractional crystallization chamber, dimethyl ether and a salt containing solution comprising one or more dissolved salts to form an aqueous solution, and precipitating a first solid from the aqueous solution. Related systems and additional methods are also described.

### CROSS-REFERENCE TO RELATED APPLICATIONS

This application is a national phase entry under 35 U.S.C. § 371 of International Patent Application PCT/US2022/072792, filed Jun. 7, 2022, designating the United States of America and published as International Patent Publication WO 2022/261626 A1 on Dec. 15, 2022, which claims the benefit under Article 8 of the Patent Cooperation Treaty of U.S. Patent Application Ser. No. 63/202,324, filed Jun. 7, 2021, the disclosure of each of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The present disclosure relates to separation of solutions. More particularly, the present disclosure relates to the use of dimethyl ether (DME) to recover one or more solids from an aqueous solution as one or more precipitates.

### BACKGROUND

Hydrometallurgy involves the extraction, separation, and recovery of metals from aqueous solutions. In hydrometallurgical processes, metal is extracted from an original material (ore or recycling feed) via leaching, which produces a leachate (also referred to as a “leach liquor”) containing metal ions. However, leaching processes seldom feature high selectivity, and a variety of impurities (e.g., metals other than a target metal) may be leached from the original material into the leachate. Subsequent hydrometallurgical treatments of the leachate involve further concentrating the target metal to obtain a more pure metal compared to the concentration of the metal in the leachate. Methods of treating the leachate generally include consumption of energy, use of strong acid/base reagents, and the generation of large volumes of wastewater.

The share of metals produced hydrometallurgically has been steadily increasing in past decades, primarily due to the lower energy costs, reduced gaseous emissions, and versatility of hydrometallurgical operations compared to other metal recovery methods. Advancements in hydrometallurgy have resulted in the economic recovery of metals from low grade deposits, which is not feasible pyrometallurgically since pyrometallurgy requires the use of high temperatures to extract the target metal. While pyrometallurgical processing routes are often employed for metal recovery, pyrometallurgy requires higher energy costs and often produces undesirable gaseous by-products when compared to hydrometallurgical metal recovery. For example, molten salt electrolysis or metallothermic reduction are examples of pyrometallurgical separation and are energy intensive processes.

In recent decades, technological developments in hydrometallurgy have often been directed towards new generations of critical materials, such as rare earth elements (REEs) and battery electrode components, with an emphasis on high efficiency and waste reduction. Urban mining, or the recovery of minerals from waste products (e.g., otherwise sent to a landfill), is increasingly important in the recovery of such critical materials since the global supply of ores of such materials is decreasing. Recovery of the metals from the waste products involves leaching the metals with an acid, followed by separation of the dissolved metals in the acid leachate.

Hydrometallurgy employs a wide variety of purification approaches including solvent extraction, selective membrane separation, ion-exchange, electrochemical separations, capture via resins or activated carbon, and hydrometallurgical precipitation (HP). HP is an easily observable separation process during which a component of an aqueous solution supersaturates and precipitates as a solid, generally in the form of a salt. A common HP process is reaction crystallization, which relies on reagent-driven precipitation via formation of insoluble hydroxides, sulfides, or anions originating from inorganic or organic acids. Another conventional HP process is evaporative crystallization, during which elevated temperatures result in evaporation of a solvent (water), thus concentrating an aqueous solution and driving precipitation of dissolved solids. Solvent-driven fractional crystallization (also referred to as “solvent-driven crystallization”), also referred to as “antisolvent crystallization,” involves the addition of a water-miscible organic solvent (MOS) to an aqueous solution. The MOS dissolves into the aqueous phase and induces the supersaturation of solutes. Each of the aforementioned precipitation techniques faces its own individual disadvantages. For example, reaction crystallization necessitates reagent consumption and induces residual effects to solution chemistry; evaporative crystallization requires high energy costs and is, therefore, energy-inefficient; and solvent-driven fractional crystallization involves additional capital costs for recovery of the solvent. Most solvent-driven fractional crystallization has to-date employed MOS molecules such as methanol, ethanol, acetone, and 2-propanol, which are liquids at ambient temperature and pressure.

### BRIEF SUMMARY

In some embodiments, a method of removing one or more solids from an aqueous solution comprises introducing, into a first fractional crystallization chamber, dimethyl ether and a salt-containing solution comprising one or more dissolved salts to form an aqueous solution; and precipitating a first solid from the aqueous solution.

In additional embodiments, a system for separating one or more solids from a solution including the one or more dissolved salts comprises a fractional crystallization chamber comprising an inlet and an outlet, the inlet configured to receive an aqueous solution comprising one or more dissolved salts, a dimethyl ether source configured to provide dimethyl ether into the fractional crystallization chamber, an expander in fluid communication with the fractional crystallization chamber and configured to reduce a pressure of a treated solution from the fractional crystallization chamber, a dimethyl ether recovery chamber in fluid communication with the expander and configured to separate the dimethyl ether from the treated solution and form a gaseous dimethyl ether stream, and a compressor to compress the gaseous dimethyl ether stream and provide a high pressure dimethyl ether stream to the dimethyl ether source.

In yet additional embodiments, a method for separating one or more dissolved solids from an aqueous solution comprises introducing an aqueous solution comprising one or more dissolved solids to a fractional crystallization chamber, contacting the aqueous solution with pressurized dimethyl ether to form a first aqueous phase enriched in dimethyl ether and at least a second aqueous phase enriched in the one or more dissolved solids, and separating the first aqueous phase from the second aqueous phase to recover the one or more dissolved solids.

### BRIEF DESCRIPTION OF THE DRAWINGS

FIG. 1 is a simplified process flow diagram illustrating a system for fractional crystallization, in accordance with embodiments of the disclosure;

FIG. 2 is a simplified process flow diagram illustrating a system including multiple fractional crystallization stages for recovering one or more materials from a solid, in accordance with embodiments of the disclosure;

FIG. 3 is a simplified process flow diagram illustrating a multi-pass variable pressure precipitation system for recovering one or more solutes from a solid by passing a treated solution through multiple fractional crystallization chambers, in accordance with embodiments of the disclosure;

FIG. 4 is a simplified partial process flow diagram illustrating a system for recovering one or more solutes from a leachate, in accordance with embodiments of the disclosure;

FIG. 5 is a simplified partial process flow diagram illustrating a system for leaching one or more solid materials from a solid, in accordance with embodiments of the disclosure;

FIG. 6 is a simplified partial perspective view of a nucleation scaffold, in accordance with embodiments of the disclosure; and

FIG. 7 is a simplified partial process flow diagram illustrating a system including a fractional crystallization chamber configured to facilitate an aqueous two-phase system, in accordance with embodiments of the disclosure.

### DETAILED DESCRIPTION

According to embodiments described herein, dimethyl ether (DME) is used as a solvent in a solvent-driven fractional crystallization process to facilitate fractional crystallization of one or more solids from a salt-containing solution, which may be formed by, for example, leaching a metal (e.g., an ore, a battery material, a rare earth magnet) with a solvent, such as an acid solution. The salt-containing solution may include one or more dissolved salts. The one or more dissolved salts may include at least one of one or more dissolved rare earth metal salts, one or more dissolved transition metal salts, one or more dissolved noble metal salts, one or more dissolved platinum group metal salts, one or more dissolved metalloid salts, one or more dissolved Group I element salts, and one or more dissolved Group II element salts. The DME is introduced to a fractional crystallization chamber where it contacts the salt-containing solution to form an aqueous solution in which the DME solvates. The DME may be a pressurized gas (e.g., having a pressure greater than atmospheric pressure) or may be a liquid. The increased pressure of the DME increases the amount of DME that may dissolve into the aqueous solution in the fractional crystallization chamber. The DME may be used to selectively precipitate solutes (e.g., dissolved solids, such as, by way of non-limiting example, transition metal salts and/or rare earth element salts (e.g., lanthanide series salts)) from the aqueous solution to form a solid precipitate (also simply referred to herein as a “solid” or a “precipitate”) and a treated solution. In some embodiments, selective precipitation of the solutes is facilitated by the temperature and/or the pressure of the fractional crystallization process. The precipitate is recovered and may be further treated. The pressure of the treated solution is reduced to separate the DME from the aqueous solution and form a treated aqueous stream and a purified solvent (also referred to as a “regenerated solvent” or a “low pressure DME stream”). The purified solvent stream may be compressed and recycled for reuse in the system and the treated aqueous solution may be recycled in the system and/or reused for leaching of additional solids (e.g., metals) from a solid from which one or more materials are to be extracted.

The precipitate may be treated in one or more additional fractional crystallization stages to further purify the precipitate. In some embodiments, the treated solution is passed through an additional fractional crystallization treatment to selectively remove an additional material (e.g., a different metal salt) from the treated solution than the metal salts removed in the previous fractional crystallization pass. The additional fractional crystallization pass may be operated at a different temperature, a different pressure, or both compared to the previous fractional crystallization pass to facilitate precipitation of one or more different solids (e.g., metal salts) from the treated solution. The system may include a desired number of fractional crystallization passes for purification of one or more solids and a desired number of fractional crystallization chambers for selectively removing one or more different solids from the salt-containing solution and the treated solution. Each fractional crystallization chamber may be configured to facilitate combining (e.g., mixing) of the salt-containing solution and/or the treated solution with pressurized DME. The DME may be separated from the treated solution leaving each fractional crystallization chamber by reducing the pressure of the treated solution to separate the DME. The separated DME may be re-pressurized for reuse in the system.

Accordingly, the fractional crystallization process with the DME solvent reduces the amount of solvent consumed and the generation of waste products in the fractional crystallization process. In addition, precipitating the solids (e.g., metal salts) from the salt-containing solution based on the temperature and/or pressure utilizes significantly less energy than separation methods that rely on thermal or evaporative precipitation processes. Further, the treated solution remains substantially unchanged in nature (e.g., pH, salts contained in solution other than the precipitated salts), facilitating the reuse of the treated solution for leaching or in other hydrometallurgical processes. Since DME is relatively non-toxic and easy to remove from the treated solution (since the DME evaporates as a gas at ambient conditions (e.g., the DME readily evaporates)), no additional reagents are utilized during the process, and toxic byproducts are minimized during the recovery of the one or more solids (e.g., metal salts) from the salt-containing solution.

In some embodiments, recovery of one or more solids (e.g., metal salts) from the salt-containing solution with DME may reduce reagent costs and corresponding downstream environmental effects when compared to conventional recovery processes. For example, conventional chemical separations that utilize ionic liquids and extractants frequently employ strong acids, require significant water resources, and suffer from extractant losses during the separation process.

A variety of dissolved solids (e.g., solutes, such as dissolved metal salts or molecules) may be recovered from a salt-containing solution using the processes described herein. Because the described process is a physical separation, the process may be conducted on a wide range of materials and solutions. Rare earth elements may be selectively precipitated from a salt-containing solution containing rare earth elements (e.g., in the form of rare earth salts) and other metals (e.g., in the form of metal salts). By way of example, lanthanides and transition metals (other than iron, such as cobalt) may be selectively precipitated from the salt-containing solution in the presence of iron. In some embodiments, iron is precipitated with cobalt. In some embodiments, one of transition metal salts and rare earth element salts may be recovered from a salt-containing solution including dissolved transition metal salts and rare earth element salts, followed by recovery of the other of the transition metal salts and rare earth element salts. In other embodiments, alkali salts and alkaline earth metal salts may be precipitated from the salt-containing solution. Different solids from a salt-containing solution may be selectively precipitated by altering the partial pressure of DME and/or the temperature of the salt-containing solution. This facilitates the serial precipitation of different materials or fractions using different DME pressures and temperatures. By way of comparison, conventional leachates from rare earth magnets (e.g., Nd—Fe—B magnet leachates) are iron-rich. The iron in such leachates is conventionally precipitated through a pH neutralizer, which consumes a significant amount of chemicals. By way of comparison, the embodiments described herein facilitate recovery of the metals (e.g., iron, cobalt, neodymium, and other rare earth elements) without consuming such chemicals.

In some embodiments, the methods described herein facilitate increasing the selectivity of one or more solids (e.g., metal salts) to be recovered with an increasing concentration of the one or more solids in the salt-containing solution. By way of contrast, conventional recovery methods, such as membrane processes, the selectivity of the process declines with increasing concentration of the desired solid to be recovered (e.g., since the rejection of the membrane declines as the concentration increases, resulting in an increase in the concentration of minor components in the purified solution).

The separation described here could be applied to “hydrometallurgical separations” as well as to production of other materials including sugar, molecular drugs, chemicals, proteins, biologicals, and other dissolved solids that would be profitable to separate. In this document the terms “metal,” “salt,” “metal salt,” and “solute” are used interchangeably.

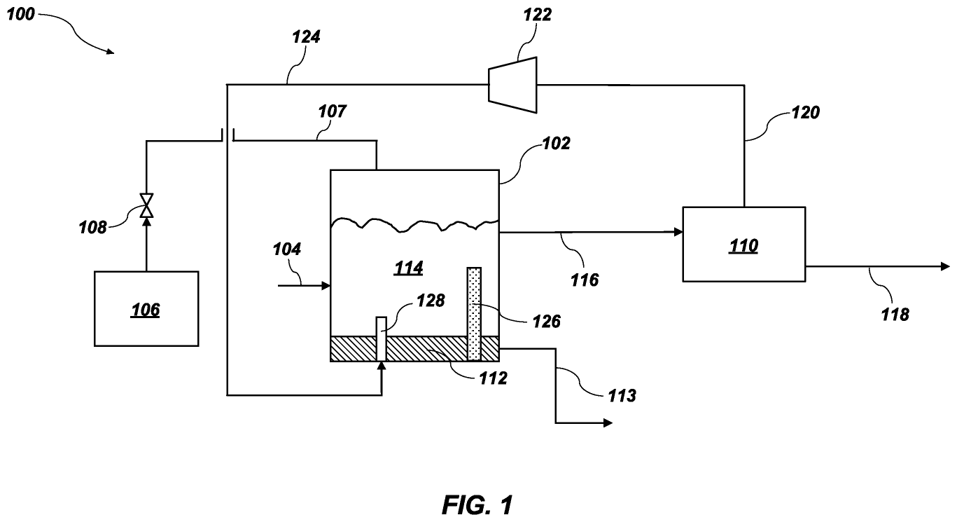

FIG. 1 is a simplified partial flow diagram, illustrating a system 100 for fractional precipitation, in accordance with embodiments of the disclosure. The system 100 includes a fractional crystallization chamber 102 configured to facilitate selective removal of one or more solids (e.g., one or more salts) from a solution 104 including one or more dissolved solids (also referred to herein as a “feed solution” or a “salt-containing solution”).

The solution 104 may include one or more dissolved salts. The solution 104 may include a chemical compound, such as one or more of a metal compound, a metalloid compound, a salt of a metal, a salt of a metalloid, an alkali salt, and an alkaline salt. The solution 104 may include a leachate of one or more of ore, electronic waste, a battery, and a magnet (e.g., a recycled magnet leachate).

In some embodiments, the solution 104 includes one or more metal ions dissolved in the solution. The one or more metal ions may include ions of at least one of one or more rare earth metal ions (e.g., one or more of lanthanides (e.g., one or more of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu))), and one or more actinides (e.g., actinium (Ac), thorium (Th), protactinium (Pa), uranium (U), neptunium (Np), plutonium (Pu), americium (Am), and curium (Cu)), scandium (Sc), yttrium (Y), one or more transition metals (e.g., one or more of titanium (Ti), vanadium (V), chromium (Cr), manganese (Mn), iron (Fe), cobalt (Co), nickel (Ni), copper (Cu), zinc (Zn), zirconium (Zr), niobium (Nb), molybdenum (Mo), technetium (Tc), ruthenium (Ru), rhodium (Rh), palladium (Pd), silver (Ag), cadmium (Cd), tantalum (Ta), tungsten (W), rhenium (Re), osmium (Os), iridium (Ir), platinum (Pt), and gold (Au)), mercury (Hg), one or more metalloids (e.g., one or more of boron (B), silicon (Si), germanium (Ge), tellurium (Te), antimony (Sb), and selenium (Se)), one or more alkali metals (e.g., one or more of lithium (Li), sodium (Na), potassium (K), rubidium (Rb), and caesium (Cs)), and one or more alkaline metals (e.g., one or more of beryllium (Be), magnesium (Mg), calcium (Ca), strontium (Sr), and barium (Ba)). In some embodiments, the one or more metals are present as one or more metal salts, such as metal sulfates, which dissolve in the solution to form the ions. As used herein, “metal salts” may include salts of one or more of the metal ions that are present in the solution 104. In other words, “metals salts” may include salts of one or more of the metals described above with reference to the metal ions that may be present in the solution 104.

In some embodiments, the solution 104 comprises rare earth elements used in rare earth magnets, such as a leachate produced by leaching rare earth elements from a rare earth magnet. In some such embodiments, the solution 104 comprises one or more dissolved rare earth metals and in a solution comprising a leaching agent used for dissolving the one or more rare earth metals from one or more of an ore, electronic waste, a battery, and a magnet. By way of non-limiting example, in some embodiments, the solution 104 comprises a leachate including one or more of (e.g., each of) praseodymium, neodymium, dysprosium, and samarium. In other embodiments, the solution 104 comprises neodymium, iron, and boron. In yet other embodiments, the solution 104 comprises samarium and cobalt. In further embodiments, the solution 104 comprises samarium, cobalt, and iron. In additional embodiments, the solution 104 comprises neodymium, praseodymium, dysprosium, samarium, iron, and cobalt.

In some embodiments, the solution 104 comprises one or more rare earth elements and one or more transition metals. By way of non-limiting example, in some embodiments, the solution 104 comprises samarium (e.g., samarium sulfate (Sm₂(SO₄)₃)), cobalt (e.g., cobalt sulfate (CoSO₄)), and iron (e.g., iron sulfate (FeSO₄)). In other embodiments, the solution 104 comprises neodymium (e.g., neodymium sulfate (Nd₂(SO₄)₃)), praseodymium (e.g., praseodymium sulfate (Pr₂(SO₄)₃)), dysprosium (e.g., dysprosium sulfate (Nd₂(SO₄)₃)), samarium, (e.g., samarium sulfate (Sm₂(SO₄)₃)), cobalt (e.g., cobalt sulfate (CoSO₄)), and iron (e.g., iron sulfate (FeSO₄)).

In some embodiments, the solution comprises one or more rare earth metals used in fluorescent lamps and permanent magnets and a leachate used to dissolve such rare earth elements. In some such embodiments, the solution 104 comprises one or more of (e.g., each of) europium, terbium, and yttrium.

In other embodiments, the solution 104 comprises one or more of (e.g., each of) cobalt (e.g., cobalt sulfate (CoSO₄)), magnesium (e.g., magnesium chloride (MgCl)), and manganese (e.g., manganese chloride (MnCl₂)). In additional embodiments, the solution 104 comprises calcium sulfate (CaSO₄) and silicate salts (e.g., calcium silicate (CaSiO₄), magnesium silicate (MgSiO₄)).

In some embodiments, the solution 104 comprises a leachate for recovering one or more materials from a battery, such as cobalt, nickel, manganese, and lithium. In some embodiments, the solution 104 comprises one or more of (e.g., each of) cobalt, nickel, manganese, and lithium.

With continued reference to FIG. 1, the system 100 further includes a DME source 106 (e.g., a tank including DME) in operable communication with the fractional crystallization chamber 102 by means of, for example, valve 108. The DME source 106 provides a DME stream 107 to the fractional crystallization chamber 102. A solvent recovery chamber 110 is in operable communication with the fractional crystallization chamber 102.

In use and operation, the salt-containing solution 104 is introduced into the fractional crystallization chamber 102 where the salt-containing solution 104 is contacted with (e.g., mixed with) DME of the DME stream 107. The DME stream 107 is provided to the fractional crystallization chamber 102 at a sufficient pressure (and the fractional crystallization chamber 102 is maintained at a sufficient pressure) such that the DME solvates into the solution 104 to form an aqueous solution 114 including solvated DME and the solution 104. In other words, the DME of the DME stream 107 enters the aqueous phase and becomes part of the aqueous solution 114. As the DME enters the aqueous phase of the aqueous solution 114, the DME facilitates precipitation of one or more dissolved solids in the solution 104 (that are, in turn, part of the aqueous solution 114) to form a solid precipitate 112.

The DME stream 107 may comprise or consist essentially of DME. In some embodiments, the DME stream 107 includes one or more additional materials, such as, one or more organic materials (e.g., one or more of methanol, ethanol, acetone, and 2-propanol). As described in further detail herein, in some embodiments, the DME stream 107 includes residual amounts of other liquids (e.g., residual amounts of a treated solution).

Upon combining (e.g., mixing) with the DME stream 107 in the fractional crystallization chamber 102, the solution 104 may form the aqueous solution 114 and the solid precipitate 112. The aqueous solution 114 may comprise either a single aqueous phase or at least two distinct (e.g., at least partially immiscible) aqueous phases. In some embodiments, the aqueous solution 114 comprises two distinct aqueous phases including a DME-rich aqueous phase and a DME-poor aqueous phase.

Without being bound by any particular theory, it is believed that solvation of the DME in the aqueous solution 114 displaces other solutes (e.g., salts) dissolved in the aqueous solution 114 (e.g., the solids of the solid precipice 112) until an invariant point is reached to drive the precipitation of the solid precipitate 112. In other words, the DME competes with the dissolved salts and displaces at least some of the dissolved salts from the aqueous solution 114 to form the solid precipitate 112. While the precise invariant point is difficult to determine for mixed salt solutions (e.g., the aqueous solution 114), and particular to a given solution composition, once the invariant point is reached, further DME addition does not substantially further induce additional precipitation of the solid precipitate 112.

In some embodiments, as the solid precipitate 112 is formed, the aqueous solution 114 may partition into two distinct phases that are in contact with each other: a high-density aqueous phase; and a low-density aqueous phase. The two distinct phases create an aqueous two-phase system (ATPS). Partitioning of the aqueous solution 114 into the two phases (the high-density aqueous phase and the low-density aqueous phase) may be referred to as two-phase partitioning of the aqueous solution 114. The high-density aqueous phase may be located at a lower portion of the fractional crystallization chamber 102 than the low-density aqueous phase. In addition, the high-density aqueous phase may include a higher concentration of dissolved salts than the solution 104. In some embodiments, the low-density aqueous phase comprises a lower dissolved salt concentration and a greater DME concentration (e.g., DME rich) than the high-density aqueous phase. In some such embodiments, the high-density aqueous phase is DME poor and comprises less DME than the low-density aqueous phase. In some embodiments, a liquid DME phase forms vertically above the low-density aqueous phase. In some embodiments, the two-phase aqueous solution is formed under pseudo-equilibrium conditions (e.g., quasi-steady state conditions).

The two-phase partitioning of the aqueous solution 114 when contacted by the DME may result in up to four separate phases being produced within the fractional crystallization chamber 102 including the solid precipitate 112; a liquid DME phase; a low-density aqueous phase; and a high-density aqueous phase. In some embodiments, the relative ratio of dissolved solids (e.g., salts) in each of the phases may differ. Accordingly, contacting the solution 104 with the DME stream 107 may facilitate selectively drawing one or more desired dissolved solids (e.g., metal salts) into either of the two aqueous phases, in the liquid DME phase, or as a solid precipitate 112. In some embodiments, the density differences between the liquid DME phase, the low-density aqueous phase, the high-density aqueous phase, and the solid precipitate 112 facilitate recovery of one or more desired dissolved salts in the solid precipitate 112.

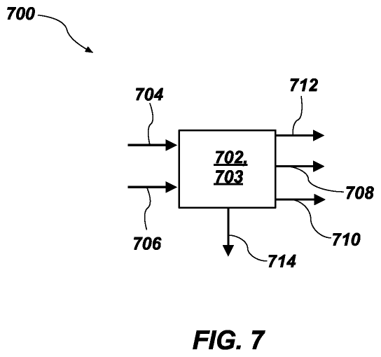

In some embodiments, the four separate phases (e.g., the solid precipitate 112, the liquid DME phase, the low-density aqueous phase, and the high-density aqueous phase) may be separated from one another based on differences in density and gravity separation. By way of non-limiting example, in some embodiments, the fractional crystallization chamber 102 includes a transfer system to separate the low-density aqueous phase from the high-density aqueous phase. As described in further detail herein and with respect FIG. 7, the fractional crystallization chamber 102 may include a separate outlet for each of the solid precipitate 112, the liquid DME phase, the low-density aqueous solution, and the high-density aqueous solution.

The low-density aqueous phase (the DME-rich aqueous phase) may include a lower concentration of dissolved salts than the high-density aqueous phase and may be treated in a downstream process to recover the DME from the low-density aqueous phase. The DME may be recovered (e.g., by reducing the pressure of the low-density aqueous phase to separate the DME from the treated solution within the low-density aqueous phase) and the recovered DME may be reused, such as for leaching one or more solids from a solid-containing material (e.g., one or more of ore, electronic waste, a battery, and a magnet). After DME is removed from the low-density aqueous phase and separated from the treated solution, the treated solution may be further processed, such as by recycling to the salt-containing solution 104 or in another downstream process.

The high-density aqueous phase (the DME-poor aqueous phase) may include a greater concentration of dissolved salts than the low-density aqueous phase and may be treated in a downstream process to recover the DME from the high-density aqueous phase. The DME may be recovered (e.g., by reducing the pressure of the high-density aqueous phase to separate the DME from the treated solution within the high-density aqueous phase) and the recovered DME may be reused, such as for leaching one or more solids from a solid-containing material (e.g., one or more of ore, electronic waste, a battery, and a magnet). After DME is removed from the high-density aqueous phase and separated from the treated solution, the treated solution may be further processed, such as by passing through an additional fractional crystallization chamber. In some embodiments, a concentration of the salts in the treated solution is greater than a concentration of dissolved salts in the salt-containing solution 104.

In some embodiments, the dissolved salt concentrations in the high-density aqueous phase are limited by conventional solubility limits. Accordingly, a salt solution (e.g., the solution 104) that is initially near saturation will enrich during contact with the DME less than a salt solution that is further from saturation. Tuning of the aqueous phase partitioning of the dissolved salts may influence the concentrations of individual salts from a mixed salt solution in each aqueous phase, presenting opportunities for improved selectivity in separations.

In some embodiments, the two-phase aqueous behavior provides a useful separation route for the dissolved solids (e.g., dissolved salts) in the aqueous solution 114 and facilitates achieving a concentrated solution in a manner distinct from conventional dewatering technologies. For example, the low-density aqueous phase may include salt concentrations that are more dilute than what is possible with processes that achieve full equilibrium conditions, while the concentrations of the high-density aqueous phase are achieved with limited energy expenditures compared to existing dewatering technologies. The high-density aqueous solution may offer benefits for downstream solution treatments, whether with DME (facilitated by higher initial salt concentrations) or with other hydrometallurgical separation technologies.

The two-phase aqueous behavior (e.g., the formation of the low-density aqueous phase and the high-density aqueous phase) as a result of contacting the solution 104 with the DME stream 107 is unexpected. In addition, the two-phase aqueous behavior facilitates improved separation of the dissolved solids.

Without being bound by any particular theory, it is believed that contacting the solution 104 with the DME from the DME stream 107 in the fractional crystallization chamber 102 reduces the amount of free water (e.g., water not bound within a solvation environment) in the aqueous solution 114, which induces precipitation of one or more solids from the aqueous solution 114. Since DME is hygroscopic (e.g., absorbs moisture), the DME reduces the amount of free water in the aqueous solution 114. Accordingly, introducing the DME to the solution 104 to form the aqueous solution 114 reduces the ability of the aqueous solution 114 to support the dissolved solids (e.g., metal salts), which facilitates selective precipitation of the dissolved solids from the aqueous solution 114.

A pressure in the fractional crystallization chamber 102 may be within a range of from greater than atmospheric pressure to about 620.5 kPa (about 90 psi), such as from about 137.9 kPa (about 20.0 psi) to about 206.8 kPa (about 30.0 psi), from about 206.8 kPa (about 30.0 psi) to about 275.8 kPa (about 40.0 psi), from about 275.8 kPa (about 40.0 psi) to about 344.7 kPa (about 50.0 psi), from about 344.7 kPa (about 50.0 psi) to about 413.7 kPa (about 60.0 psi), from about 413.7 kPa (about 60.0 psi) to about 482.6 kPa (about 70.0 psi), from about 482.6 kPa (about 70.0 psi) to about 551.6 kPa (about 80 psi), or from about 551.6 kPa (about 80 psi) to about 620.5 kPa (about 90 psi). In some embodiments, the pressure in the fractional crystallization chamber 102 is about 528.8 kPa (about 76.7 psi). However, the disclosure is not so limited, and the pressure in the fractional crystallization chamber 102 is different than those described.

At ambient temperature and pressure, DME is gaseous. According to Henry's law, a soluble gas will dissolve into the liquid phase until equilibrium is reached and solubility of the gas in the liquid is proportional to the partial pressure of the gas above the liquid. In other words, increasing the partial pressure of the DME in the fractional crystallization chamber 102 increases the concentration of the DME in the aqueous solution 114 and, therefore, increases the formation of the solid precipitate 112. Accordingly, the solubility of the DME in the aqueous phase 114 may be controlled by controlling the temperature of the aqueous phase 114 in the fractional crystallization chamber 102. In addition, DME has a high solubility in water, further increasing the effectiveness of using DME as a solvent.

A temperature in the fractional crystallization chamber 102 may be within a range of from about −30° C. to about 60° C., such as from about −30° C. to about −20° C., from about −20° C. to about −10° C., from about −10° C. to about 0° C., from about 0° C. to about 10° C., from about 10° C. to about 20° C., from about 20° C. to about 30° C., from about 30° C. to about 40° C., from about 40° C. to about 50° C., or from about 50° C. to about 60° C. In some embodiments, the temperature of the fractional crystallization chamber 102 is from about 20° C. to about 50° C. In some embodiments, the temperature of the fractional crystallization chamber 102 is about 20° C. In other embodiments, the temperature of the fractional crystallization chamber 102 is about 30° C., or about 31° C.

In some embodiments, the temperature of the fractional crystallization chamber 102 is controlled to facilitate selective removal and separation of metal salts from the solution 104. In some embodiments, a solubility of one or more metal salts in the aqueous phase 114 may change as a function of temperature. By way of non-limiting example, in some embodiments, the solubility of one or more metal salts in the aqueous phase 114 may increase with increasing temperature and the solubility of one or more other metal salts in the aqueous phase 114 may decrease with increasing temperature. In some such embodiments, altering (e.g., increasing or decreasing) the temperature of the aqueous phase 114 in the fractional crystallization chamber 102 may facilitate separation of one or more metal salts from the aqueous phase 114. As one non-limiting example, a solubility of transition metal sulfates (e.g., CoSO₄, FeSO₄) in the aqueous phase 114 including DME increases with increasing temperature while a solubility of rare earth element sulfates (e.g., Pr₂(SO₄)₃, Nd₂(SO₄)₃, Dy₂(SO₄)₃, Sm₂(SO₄)₃) decreases with an increasing temperature of the aqueous phase 114 including DME. Accordingly, decreasing the temperature of the aqueous phase 114 may facilitate preferential (e.g., selective) precipitation of the rare earth element sulfates relative to the transition metal sulfates (which may remain dissolved in the aqueous phase 114). As described in further detail herein, in some embodiments, the solution 104 may be passed through a series of fractional crystallization chambers 102 at different operating temperatures to selectively remove different solids (e.g., metal salts) from each of the fractional crystallization chambers 102.

In some embodiments, the fractional crystallization chamber 102 includes a nucleation scaffold 126 formulated and configured to facilitate precipitation of one or more dissolved salts within the aqueous solution 114 and form the solid precipitate 112. The nucleation scaffold 126 may comprise a surface on which the solid precipitate 112 may form. In some embodiments, the nucleation scaffold 126 facilitates recovery of the solid precipitate 112 at a defined location/surface within the fractional crystallization chamber 102, enabling more efficient process recovery of the solid precipitate 112. Moreover, the material composition and surface area of the nucleation scaffold 126 may be tailored based on the composition of the solution 104 and the solid precipitate 112. In some embodiments, the nucleation scaffold 126 comprises seed crystals of the solid precipitate 112 to encourage favorable thermodynamic conditions for crystallization of the solid precipitate 112. In some embodiments, the nucleation scaffold 126 is configured to improve the mass transfer kinetics and surface-selectivity of the solid precipitate 112 such as, for example, REE precipitation. Tuning of surfaces of the nucleation scaffold 126 may facilitate additional control to the precipitation. In other words, the nucleation scaffold 126 may provide a high energy surface to facilitate nucleation and increase the crystallization kinetics of the solid precipitate 112. In some embodiments, because crystallization is operationally more easily controlled than nucleation, seed crystals may be used to sidestep nucleation events.

The DME and portions of the solution 104 (e.g., the solvent) that do not precipitate remain in the aqueous phase 114 and exit the fractional crystallization chamber 102 in a treated solution 116 (also referred to as a “treated aqueous solution”). The treated solution 116 enters the solvent recovery chamber 110 that is at a pressure lower than the pressure of the fractional crystallization chamber 102 to facilitate separation of the DME from the solvent of the treated solution 116 to form a low pressure treated aqueous solution 118 and a low pressure DME stream 120.

In some embodiments, the low pressure treated aqueous solution 118 is recycled to a process configured to leach one or more metals from a material (e.g., ore, electronic waste, rare earth magnets, battery materials) and to generate the solution 104. In other embodiments, the low pressure treated aqueous solution 118 is treated in a downstream process, such as to remove additional dissolved solids from the low pressure treated aqueous solution 118. The low pressure DME stream 120 is compressed in a pressure-increasing apparatus 122 to form pressurized DME 124. The pressurized DME 124 is recycled to the fractional crystallization chamber 102 to selectively precipitate one or more salts from the solution 104, as previously described.

The pressure-increasing apparatus 122 may include a pump (e.g., a gear pump), such as where the pressurized DME 124 comprises a liquid. In other embodiments, such as where the pressurized DME 124 comprises a gas, the pressure-increasing apparatus 122 comprises a compressor.

With continued reference to FIG. 1, the pressurized DME 124 may be introduced to the fractional crystallization chamber 102 at inlet 128. In some embodiments, the inlet 128 is located at the bottom of the fractional crystallization chamber 102 proximate the solid precipitate 112. In some embodiments, the inlet 128 comprises a sparger configured to agitate the aqueous phase 114 with the pressurized DME 124. In some embodiments, the sparger is configured to provide the pressurized DME 124 to the fractional crystallization chamber 102 as bubbles.

The sparger may be configured to control one or more of the bubble size, the flow rate, and the pressure of the pressurized DME 124.

The solid precipitate 112 is removed from the fractional crystallization chamber 102 as a solid stream 113.

Accordingly, the DME may be recompressed and reused in the fractional crystallization chamber 102, while the low pressure treated aqueous solution 118 may be further treated in a downstream system. The low boiling point of DME helps facilitate the recovery of DME from the treated solution 116. Since the DME readily evaporates from the solution at ambient temperature and pressure, reagents are not consumed and the DME is recycled back to the fractional crystallization chamber 102 to facilitate precipitation of additional salts from the salt-containing solution 104. In some embodiments, the DME may be regenerated to form the pressurized DME 124 without heating the DME. Accordingly, the ease of recovery of the DME solvent makes the system 100 an energy efficient system 100 for selective removal of dissolved solids from a salt-containing solution 104. By way of comparison, conventional solvent-based recovery systems require solvent regenerations by distillation, which is an energy intensive process. Accordingly, a DME extraction process may be much more energy efficient than a conventional crystallization process to separate a solute from an aqueous solution.

In some embodiments, the system 100 may be used to selectively separate one or more rare earth elements from one or more transition metals from a solution including dissolved rare earth element salts and transition metal salts. By way of non-limiting example, samarium sulfate may be selectively precipitated from a solution comprising dissolved samarium sulfate and cobalt sulfate by introducing the solution to the fractional crystallization chamber 102 and operating the fractional crystallization chamber 102 at about 31° C. In some such embodiments, the solid stream 113 comprises samarium sulfate and the cobalt sulfate remains in the treated solution 116. In other embodiments, by adjusting the temperature of the fractional crystallization chamber 102 to about 20° C., the cobalt sulfate preferentially precipitates as the solid stream 113 and the samarium sulfate remains in the treated solution 116. In some embodiments, the initial solution includes samarium sulfate, cobalt sulfate, and iron sulfate. In some such embodiments, the iron sulfate may remain substantially with the cobalt sulfate (e.g., either precipitate with the cobalt sulfate or remain in the treated solution 116 with the cobalt sulfate).

In another embodiment, a solution comprising dissolved iron sulfate, cobalt sulfate, neodymium sulfate, praseodymium sulfate, samarium sulfate, and dysprosium sulfate may be treated in the system 100. In some embodiments, the solution is introduced to the fractional crystallization chamber 102 within a range of from about 20° C. to about 40° C., such as from about 20° C. to about 30° C., or from about 30° C. to about 40° C. In some embodiments, the temperature is about 31° C. In some such embodiments, the solid stream 113 comprises the neodymium sulfate, praseodymium sulfate, samarium sulfate, and dysprosium sulfate while the treated solution 116 comprises the iron sulfate and cobalt sulfate.

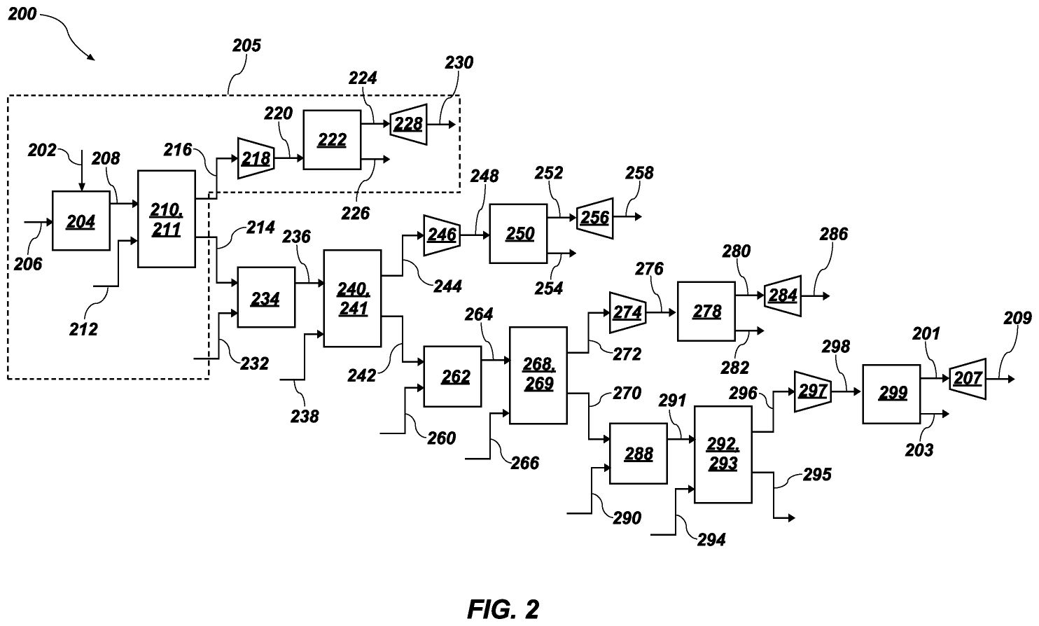

Although the system 100 has been described and illustrated as including only a single fractional crystallization chamber 102, the disclosure is not so limited. FIG. 2 is a simplified process flow diagram illustrating a system 200 of recovering one or more materials from a solid 202. The system 200 may be referred to as a DME-driven continuous sequential precipitation system and may be configured for effectuating a DME-driven continuous sequential precipitation process. The system 200 may also be referred to herein as a “multi-stage” system for recovering the one or more materials from the solid 202. In some embodiments, the solid 202 includes a material including one or more metal salts desired to be extracted from the solid 202 and recovered in the system 200. By way of non-limiting example, the solid 202 includes one or more of an ore, electronic waste, a magnet (e.g., a rare earth magnet), and a battery material (e.g., a battery electrode).

The system 200 includes one or more fractional crystallization stages configured for recovering one or more materials from the solid 202. For example, a first fractional crystallization stage 205, illustrated in the dashed box. In some embodiments, the first fractional crystallization stage 205 includes a leaching chamber 204 to obtain a first-salt containing solution 208, a first fractional crystallization chamber 210 for removing one or more materials from the first-salt containing solution 208 with a first DME stream 212, to obtain a first solid 214 and a first treated solution 216, a first expander 218 for decompressing the DME from the first DME stream 212 to form a low pressure first treated solution 220, a first solvent recovery chamber 222 for separating the DME from a first low pressure treated aqueous solution 226 as a first gaseous DME stream 224, and a first compressor 228 for increasing the pressure of the first gaseous DME stream 224 to form a first pressurized DME stream 230 for reuse (e.g., recycling) in the system 200.

The leaching chamber 204 is configured to combine (e.g., mix) a leaching solution 206 with the solid 202 and facilitate contacting the solid 202 with the leaching solution 206 to selectively leach one or more solids from the solid 202 and form the first salt-containing solution 208. The leaching solution 206 may also be referred to herein as a “lixiviant.” The leaching solution 206 contacts the solid 202 in the leaching chamber 204 to dissolve one or more materials (e.g., metals) from the solid 202 and form the first salt-containing solution 208. Accordingly, the leaching solution 206 interacts with the solid 202 to extract materials of interest (e.g., metal salts). The first salt-containing solution 208 may be referred to herein as a “leachate.” In some embodiments, the salts dissolved in the first salt-containing solution 208 comprises metal salts. In some such embodiments, the cations of the metal salt comprise a material from the leaching solution 206. By way of non-limiting example, where the leaching solution 206 comprises sulfuric acid, the first salt-containing solution 208 may include metal sulfate salts, such as, for example, rare earth metal sulfates (e.g., samarium sulfate, neodymium sulfate, praseodymium sulfate, dysprosium sulfate) and/or transition metal sulfates (e.g., cobalt sulfate, iron sulfate).

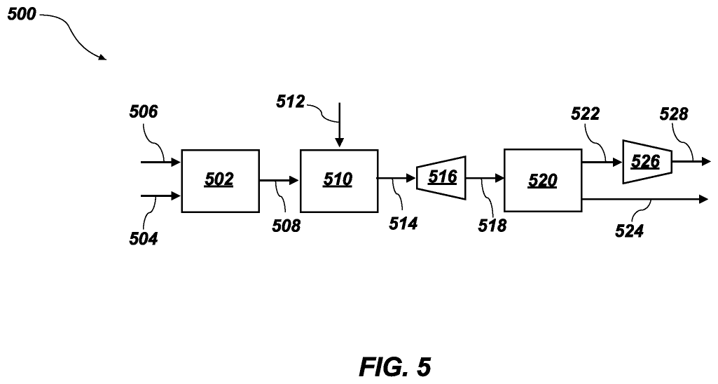

The leaching solution 206 may comprise one or more materials formulated and configured to leach one or more materials (e.g., salts) from the solid 202. In some embodiments, the leaching solution 206 comprises one or more of sulfuric acid (H₂SO₄), oxalic acid (H₂C₂O₄), hydrochloric acid (HCl), nitric acid (HNO₃), citric acid (C₆H₈O₇), acetic acid (CH₃COOH), hydrogen peroxide (H₂O₂), ammonium sulfate ((NH₄)₂(SO₄)), hydrofluoric acid (HF), bromine (Br₂), chlorine (Cl₂), bromic acid (HBrO₃), iodic acid (HIO₃), ferrous ions (Fe²⁺), and copper ions (Cu²⁺). In some embodiments, and as described in further detail below with respect to FIG. 5, in some embodiments, the leaching solution 206 may include pre-dissolved DME, which may limit the dissolution of solutes in the first salt-containing solution 208.

The first salt-containing solution 208 may comprise one or more of the materials and compositions described above with reference to the salt-containing solution 104 (FIG. 1). In some embodiments, the first salt-containing solution 208 comprises one or more rare earth elements and one or more transition metal elements.

The first salt-containing solution 208 is introduced to the first fractional crystallization chamber 210 where it is mixed with a first DME stream 212 to form a first aqueous solution 211. The first DME stream 212 may comprise liquid DME or gaseous DME, depending on the temperature and pressure of the first DME stream 212 and the temperature and pressure of the first fractional crystallization chamber 210. In some embodiments, the first DME stream 212 comprises liquid DME. In other embodiments, the first DME stream 212 comprises gaseous DME. An amount of DME in the first aqueous solution 211 depends, at least in part, on the temperature and pressure of the first DME stream 212 and the temperature and pressure of the first fractional crystallization chamber 210. The amount of DME in the first aqueous solution 211 may be within a range of from about 0.5 weight percent to about 36 weight percent, such as from about 0.5 weight percent to about 1.0 weight percent, from about 1.0 weight percent to about 5.0 weight percent, from about 5.0 weight percent to about 10.0 weight percent, from about 10.0 weight percent to about 20.0 weight percent, from about 20.0 weight percent to about 30.0 weight percent, or from about 30.0 weight percent to about 36.0 weight percent.

A pressure of each of the first DME stream 212 and the first fractional crystallization chamber 210 may be the same as the pressure of the fractional crystallization chamber 102 (FIG. 1) described above. For example, the pressure of first DME stream 212 and the first fractional crystallization chamber 210 may be within a range of from greater than atmospheric pressure to about 620.5 kPa (about 90 psi). In some embodiments, the pressure of each of the first DME stream 212 and the first fractional crystallization chamber 210 is about 528.8 kPa (about 76.7 psi). As described above, the pressure of the first DME stream 212 and the first fractional crystallization chamber 210 influences the amount of DME that is solvated (dissolved) into the first aqueous solution 211.

In the first fractional crystallization chamber 210, the first DME stream 212 interacts with the first salt-containing solution 208 and selectively removes one or more solids (e.g., metal salts) from the first salt-containing solution 208 to form a first solid 214 and a first treated solution 216 from which one or more solids (e.g., metal salts) have been removed. The first treated solution 216 may include the DME and portions of the first salt-containing solution 208 other than the solids removed in the first solid 214. In some embodiments, the greater the amount of DME that solvates into the first salt-containing solution 208, the greater the fraction of separation of one or more materials (e.g., metal salts) from the first salt-containing solution 208 to form the first solid 214.

In some embodiments, the first treated solution 216 passes through the first expander 218 to reduce the pressure of the first treated solution 216 and form the low pressure first treated solution 220. A pressure of the low pressure first treated solution 220 may be less than the pressure of the first DME stream 212. The low pressure first treated solution 220 enters the first solvent recovery chamber 222 (also referred to as a “first agent recovery chamber”) where the DME is evaporated and recovered from the remaining portions of the first salt-containing solution 208 to form the first gaseous DME stream 224 and the first low pressure treated aqueous solution 226.

The first low pressure treated aqueous solution 226 may include portions of the leaching solution 206 that remain in the first aqueous solution 211 (e.g., that were not removed in the first solid 214). In some embodiments, the first low pressure treated aqueous solution 226 comprises water and solute that was not precipitated in the first solid 214. In some embodiments, the first low pressure treated aqueous solution 226 may be recycled in the system 200. For example, the first low pressure treated aqueous solution 226 may be recycled to the leaching solution 206 provided to the leaching chamber 204. In other embodiments, the first low pressure treated aqueous solution 226 is processed downstream, such as by passing the first low pressure treated aqueous solution 226 through one or more additional fractional crystallization chambers to selectively remove one or more additional materials from the first low pressure treated aqueous solution 226.

The first gaseous DME stream 224 is pressurized with the first compressor 228 to form the first pressurized DME stream 230. The first pressurized DME stream 230 may be recycled in the system 200, such as to the first DME stream 212, a second DME stream 238, a third DME stream 266, or a fourth DME stream 294.

Accordingly, with reference to FIG. 2, the first fractional crystallization stage 205 illustrated in the dashed box includes the leaching chamber 204, the first fractional crystallization chamber 210, the first expander 218, the first solvent recovery chamber 222, and the first compressor 228. The first solid 214 may be further processed in additional fractional crystallization stages, as described in further detail herein.

For example, the first solid 214 may be further treated in a second fractional crystallization stage that includes a first mixing chamber 234 (also referred to as a “first combining chamber”), a second fractional crystallization chamber 240, a second expander 246, a second solvent recovery chamber 250, and a second compressor 256. The second fractional crystallization stage may be substantially similar to the first fractional crystallization stage 205, except that the second fractional crystallization stage includes the first mixing chamber 234 rather than the leaching chamber 204.

With continued reference to FIG. 2, the first solid 214 may be mixed with a first solvent 232 in the first mixing chamber 234 to form a second salt-containing solution 236. In some embodiments, the first solvent 232 comprises water. In some embodiments, the first solvent 232 includes recycled portions of a second low pressure treated aqueous solution 254, a third low pressure treated aqueous solution 282, or a fourth low-pressure treated aqueous solution. In other embodiments, the first solvent 232 comprises an aqueous stream from another system.

The first solid 214 dissolves in the first solvent 232 in the first mixing chamber 234 to form the second salt-containing solution 236. The second salt-containing solution 236 includes dissolved materials (e.g., dissolved metal salts) from the first solid 214.

The second salt-containing solution 236 is mixed and contacted with a second DME stream 238 in a second fractional crystallization chamber 240 to form a second aqueous solution 241. The second fractional crystallization chamber 240 may be substantially similar to the first fractional crystallization chamber 210, except that the second fractional crystallization chamber 240 may be operated at one or more of a different temperature, a different temperature, or may include a different volume of mixed solution (e.g., the volume of the second aqueous solution 241 may be different than the volume of the first aqueous solution 211) than the first fractional crystallization chamber 210.

The second DME stream 238 may be substantially similar to the first DME stream 212 and may comprise liquid DME or pressurized gaseous DME. In some embodiments, an amount of DME in the second aqueous solution 241 may be within a range of from about 0.5 weight percent to about 36 weight percent, such as from about 0.5 weight percent to about 1.0 weight percent, from about 1.0 weight percent to about 5.0 weight percent, from about 5.0 weight percent to about 10.0 weight percent, from about 10.0 weight percent to about 20.0 weight percent, from about 20.0 weight percent to about 30.0 weight percent, or from about 30.0 weight percent to about 36.0 weight percent. Remaining portions of the second aqueous solution 241 may be formed from the second salt-containing solution 236 (e.g., including the first solvent 232 and the first solid 214).

A pressure of the second DME stream 238 may be substantially similar to the pressure of the first DME stream 212 and may be within a range of from greater than atmospheric pressure to about 620.5 kPa (about 90 psi). In some embodiments, the pressure of the second DME stream 238 provides a pressure to the second fractional crystallization chamber 240. In some embodiments, and as described above, the pressure of the second DME stream 238 and the second fractional crystallization chamber 240 influences the amount of DME that is solvated (dissolved) into the second aqueous solution 241, and thus, the amount and/or composition of second solid 242 precipitated from the second aqueous solution 241. In some embodiments, the pressure of the second DME stream 238 is less than the pressure of the first DME stream 212. In some such embodiments, the pressure of the second fractional crystallization chamber 240 is less than the pressure of the first fractional crystallization chamber 210.

As described above with reference to the first fractional crystallization chamber 210, in the second fractional crystallization chamber 240, the second DME stream 238 interacts with the second salt-containing solution 236 and selectively removes one or more dissolved solids (e.g., metal salts) from the second salt-containing solution 236 to form the second solid 242 and a second treated solution 244 from which one or more solids have been removed. In some embodiments, the second DME stream 238 absorbs water from the second salt-containing solution 236 to facilitate separation of the solids from the second aqueous solution 241.

The second treated solution 244 may include the DME of the second DME stream 238 and portions of the second salt-containing solution 236 other than the solids removed in the second solid 242. In some embodiments, the greater the amount of DME that solvates in the second aqueous solution 241, the greater the fraction of separation of one or more metal salts from the second salt-containing solution 236.

In some embodiments, the second treated solution 244 passes through a second expander 246 to reduce the pressure of the second treated solution 244 and form a low pressure second treated solution 248. A pressure of the low pressure second treated solution 248 may be less than the pressure of the second DME stream 238. The low pressure second treated solution 248 enters a second solvent recovery chamber 250 (also referred to as a “second agent recovery chamber”) where the DME is evaporated and recovered from the remaining portions of the second aqueous solution 241 to form a second gaseous DME stream 252 and a second low pressure treated aqueous solution 254.

The second low pressure treated aqueous solution 254 may include portions of the second salt-containing solution 236 that remain in the second aqueous solution 241 (e.g., that were not removed in the second solid 242). In some embodiments, the second low pressure treated aqueous solution 254 comprises water and solute that was not precipitated in the second solid 242. In some embodiments, the second low pressure treated aqueous solution 254 may be recycled in the system 200. For example, the second low pressure treated aqueous solution 254 may be recycled to the leaching solution 206 provided to the leaching chamber 204 or to the first solvent 232 provided to the first mixing chamber 234. In other embodiments, the second low pressure treated aqueous solution 254 may be treated in a downstream process to remove additional dissolved materials from the second low pressure treated aqueous solution 254. By way of non-limiting example, the second low pressure treated aqueous solution 254 may be passed through one or more additional fractional crystallization chambers to selectively remove one or more additional solids from the second low pressure treated aqueous solution 254.

The second gaseous DME stream 252 is pressurized with a second compressor 256 to form a second pressurized DME stream 258. The second pressurized DME stream 258 may be recycled in the system 200, such as to the first DME stream 212 or to the second DME stream 238.

The second solid 242 may be further processed in an additional fraction crystallization stage (e.g., third fractional crystallization chamber 268), as described above with reference to the first solid 214. By way of non-limiting example, the second solid 242 may be mixed with a second solvent 260 in a second mixing chamber 262 (also referred to as a “second combining chamber”) to form a third salt-containing solution 264 including dissolved solids from the second solid 242 and the second solvent 260. In some embodiments, the second solvent 260 comprises one or more of the materials described above with reference to the first solvent 232. In some embodiments, the second solvent 260 comprises water.

With continued reference to FIG. 2, the third salt-containing solution 264 is mixed and contacted with a third DME stream 266 in a third fractional crystallization chamber 268 to form a third aqueous solution 269. The third fractional crystallization chamber 268 may be substantially similar to the first fractional crystallization chamber 210 and the second fractional crystallization chamber 240, except that the third fractional crystallization chamber 268 may be operated at one or more of a different temperature, a different temperature, or may include a different volume (e.g., the volume of the third aqueous solution 269 may be different than the volume of the first aqueous solution 211 and/or the volume of the second aqueous solution 241) than the first fractional crystallization chamber 210 and the second fractional crystallization chamber 240.

The third DME stream 266 may be substantially similar to the first DME stream 212 and the second DME stream 238 and may comprise liquid DME or pressurized gaseous DME. In some embodiments, an amount of DME in the third aqueous solution 269 may be within a range of from about 0.5 weight percent to about 36 weight percent, such as from about 0.5 weight percent to about 1.0 weight percent, from about 1.0 weight percent to about 5.0 weight percent, from about 5.0 weight percent to about 10.0 weight percent, from about 10.0 weight percent to about 20.0 weight percent, from about 20.0 weight percent to about 30.0 weight percent, or from about 30.0 weight percent to about 36.0 weight percent. Remaining portions of the third aqueous solution 269 may be formed from the third salt-containing solution 264 (e.g., including the second solvent 260 and the second solid 242).

A pressure of the third DME stream 266 may be substantially similar to the pressure of the first DME stream 212 and the second DME stream 238 and may be within a range of from greater than atmospheric pressure to about 620.5 kPa (about 90 psi). In some embodiments, the pressure of the third DME stream 266 provides a pressure to the third fractional crystallization chamber 268. In some embodiments, and as described above, the pressure of the third DME stream 266 and the third fractional crystallization chamber 268 influences the amount of DME that is solvated (dissolved) into the third aqueous solution 269, and thus, the amount and/or composition of third solid 270 precipitated from the third aqueous solution 269. In some embodiments, the pressure of the third DME stream 266 is less than the pressure of the first DME stream 212 and the second DME stream 238. In some such embodiments, the pressure of the third fractional crystallization chamber 268 is less than the pressure of the first fractional crystallization chamber 210 and the second fractional crystallization chamber 240.

As described above with reference to the first fractional crystallization chamber 210, in the third fractional crystallization chamber 268, the third DME stream 266 interacts with the third salt-containing solution 264 and selectively removes one or more solids (e.g., metal salts) from the third salt-containing solution 264 to form the third solid 270 and a third treated solution 272 from which one or more solids have been removed. In some embodiments, the third DME stream 266 absorbs water from the third salt-containing solution 264 to facilitate separation of the solids from the third aqueous solution 269.

The third treated solution 272 may include the DME of the third DME stream 266 and portions of the third salt-containing solution 264 other than the solids removed in the third solid 270. In some embodiments, the greater the amount of DME that solvates in the third aqueous solution 269 the greater the fraction of separation of one or more metal salts from the third salt-containing solution 264.

In some embodiments, the third treated solution 272 passes through a third expander 274 to reduce the pressure of the third treated solution 272 and form a low pressure third treated solution 276. A pressure of the low pressure third treated solution 276 may be less than the pressure of the third DME stream 266. In some embodiments, the pressure of the low pressure third treated solution 276 is less than the pressure of each of the low pressure first treated solution 220 and the low pressure second treated solution 248 and may, therefore, also be referred to herein as a “reduced pressure third treated solution 276.” The low pressure third treated solution 276 enters a third solvent recovery chamber 278 (also referred to as a “third agent recovery chamber”) where the DME is evaporated and recovered from the remaining portions of the third aqueous solution 269 to form a third gaseous DME stream 280 and a third low pressure treated aqueous solution.

The third low pressure treated aqueous solution 282 may include portions of the third salt-containing solution 264 that remain in the third aqueous solution 269 (e.g., that were not removed in the third solid 270). In some embodiments, the third low pressure treated aqueous solution 282 comprises water and solute that was not precipitated in the third solid 270. In some embodiments, the third low pressure treated aqueous solution 282 may be recycled in the system 200. For example, the third low pressure treated aqueous solution 282 may be recycled to the leaching solution 206 provided to the leaching chamber 204, to the first solvent 232 provided to the first mixing chamber 234, or to the second solvent 260 provided to the second mixing chamber 262. In other embodiments, the third low pressure treated aqueous solution 282 may be treated in a downstream process to remove additional dissolved materials from the third low pressure treated aqueous solution 282. By way of non-limiting example, the third low pressure treated aqueous solution 282 may be passed through one or more additional fractional crystallization chambers to selectively remove one or more additional solids from the third low pressure treated aqueous solution 282.

The third gaseous DME stream 280 is pressurized with a third compressor 284 to form a third pressurized DME stream 286. The third pressurized DME stream 286 may be recycled in the system 200, such as to the first DME stream 212, the second DME stream 238, or the third DME stream 266.

With continued reference to FIG. 2, the system 200 may include one or more additional stages of fractional crystallization, which may be substantially similar to the previous stages of fractional crystallization. By way of non-limiting example, an additional fractional crystallization stage may be configured to further purify the third solid 270 and may include, for example, a third mixing chamber 288 (also referred to as a “third combining chamber”) configured to receive the third solid 270 and a third solvent 290 to form a fourth salt-containing stream 291; a fourth fractional crystallization chamber 292 configured to receive the fourth salt-containing stream 291 and a fourth DME stream 294 to generate a fourth aqueous stream 293 to separate and form a solid product 295 and a fourth treated solution 296; a fourth expander 297 configured to reduce the pressure of the fourth treated solution 296 and generate a low pressure fourth treated fluid 298; a fourth solvent recovery chamber 299 configured to generate a fourth gaseous DME stream 201 and a fourth low pressure treated aqueous solution 203; and a fourth compressor 207 configured to pressurize the fourth gaseous DME stream 201 and a fourth pressurized DME stream 209. Each of the third mixing chamber 288, the fourth fractional crystallization chamber 292, the fourth expander 297, the fourth solvent recovery chamber 299, and the fourth compressor 207 may be substantially similar to the first mixing chamber 234, the first fractional crystallization chamber 210, the first expander 218, the first solvent recovery chamber 222, and the first compressor 228.

In some embodiments, a volume of the leaching solution 206 is greater than the volume of the first solvent 232; the volume of the first solvent 232 is greater than the volume of the second solvent 260; and the volume of the second solvent 260 is greater than the volume of the third solvent 290. In some embodiments, addition of the first solvent 232 to the first solid 214, the second solvent 260 to the second solid 242, and the third solvent 290 to the third solid 270 facilitates continuous DME treatment of the solid 202 to continuously improve the purity of the recovered solids (e.g., the first solid 214, the second solid 242, the third solid 270, and the solid product 295).

Each of the first fractional crystallization chamber 210, the second fractional crystallization chamber 240, the third fractional crystallization chamber 268, and the fourth fractional crystallization chamber 292 may individually chamber capable of pressurization to at least about 620.5 kPa (about 90 psi), as described above with reference to the fractional crystallization chamber 102 (FIG. 1). Using higher pressures in the fractional crystallization chambers, increases the solubility of the DME in the solution per Henry's law.

In some embodiments, a temperature of each of the first fractional crystallization chamber 210, the second fractional crystallization chamber 240, the third fractional crystallization chamber 268, and the fourth fractional crystallization chamber 292 may individually be within a range of from about −30° C. to about 60° C., such as from about −30° C. to about −20° C., from about 20° C. to about −10° C., from about −10° C. to about 0° C., from about 0° C. to about 10° C., from about 10° C. to about 20° C., from about 20° C. to about 30° C., from about 30° C. to about 40° C., from about 40° C. to about 50° C., or from about 50° C. to about 60° C. In some embodiments, a temperature of at least one of the first fractional crystallization chamber 210, the second fractional crystallization chamber 240, the third fractional crystallization chamber 268, and the fourth fractional crystallization chamber 292 is different from the temperature of at least another of the first fractional crystallization chamber 210, the second fractional crystallization chamber 240, the third fractional crystallization chamber 268, and the fourth fractional crystallization chamber 292. In some embodiments, a temperature of each of the first fractional crystallization chamber 210, the second fractional crystallization chamber 240, the third fractional crystallization chamber 268, and the fourth fractional crystallization chamber 292 is different from the temperature of the other of the first fractional crystallization chamber 210, the second fractional crystallization chamber 240, the third fractional crystallization chamber 268, and the fourth fractional crystallization chamber 292.

As described above with reference to the fractional crystallization chamber 102 (FIG. 1) and the nucleation scaffold 126 (FIG. 1), each of the first fractional crystallization chamber 210, the second fractional crystallization chamber 240, the third fractional crystallization chamber 268, and the fourth fractional crystallization chamber 292 may individually include a nucleation scaffold that may be substantially similar to the nucleation scaffold 126. In some embodiments, at least one of the first fractional crystallization chamber 210, the second fractional crystallization chamber 240, the third fractional crystallization chamber 268, and the fourth fractional crystallization chamber 292 includes a nucleation scaffold and at least others of the first fractional crystallization chamber 210, the second fractional crystallization chamber 240, the third fractional crystallization chamber 268, and the fourth fractional crystallization chamber 292 do not include a nucleation scaffold.

Accordingly, in some embodiments, each fractional crystallization stage of the system 200 may include an associated precipitate (e.g., the first solid 214, the second solid 242, the third solid 270, the solid product 295) with an increasing degree of purity as the stages increase. Each precipitate (e.g., the first solid 214, the second solid 242, the third solid 270) is dissolved until the final stage.

Although FIG. 2 illustrates that the system 200 includes four fractional crystallization stages, the disclosure is not so limited. In some embodiments, the system 200 includes fewer than four fractional crystallization stages and associated fractional crystallization chambers (e.g., the first fractional crystallization chamber 210, the second fractional crystallization chamber 240, the third fractional crystallization chamber 268, and the fourth fractional crystallization chamber 292) (e.g., three fractional crystallization stages, two fractional crystallization stages) or greater than four fractional crystallization stages (e.g., greater than six fractional crystallization stages, greater than eight fractional crystallization stages).

Although the system 200 of FIG. 2 has been described and illustrated as being used to recover one or more materials from the solid 202, the disclosure is not so limited. In other embodiments, the system 200 may be used to recover one or more dissolved solids from a salt-containing solution (e.g., a leachate, the salt-containing solution originated outside of the system 200). By way of non-limiting example, a saline solution (e.g., hard water (water including one or more of dissolved alkali salts, dissolved alkaline salts, and dissolved silicate salts)) may be treated in the system 200 to remove one or more dissolved solids from the hard water to soften the water. The saline solution may comprise, for example, one or more of ocean water, brine, produced water, brackish water, mineralized water, industrial waste water, mining waste (e.g., a potash solution, a gypsum solution, a lithium salt solution), an acid solution, a base solution, and a synthetic fermentation broth. In some embodiments, the system 200 includes an input comprising a saline solution at the location of the first salt-containing solution 208, and the input may be treated in one or more fractional crystallization stages to remove salt (e.g., lithium chloride, sodium chloride, calcium chloride, potassium chloride, magnesium chloride) from the saline solution. In other embodiments, the system 200 is configured to remove one or more dissolved solids from a stripping solution, such as a stripping solution used in a solvent extraction process, or from a wash solution previously associated with gases or solids.

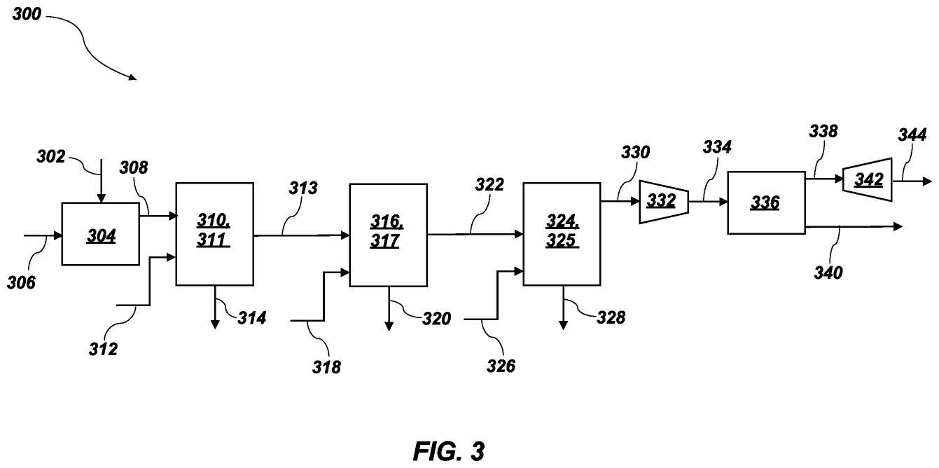

FIG. 3 is a simplified process flow diagram illustrating a multi-pass variable pressure precipitation system 300 for recovering one or more metal salts from a solid 302 by passing a treated solution through multiple fractional crystallization chambers, in accordance with embodiments of the disclosure. The system 300 may be referred to as a DME-driven variable pressure precipitation system or a “multi-pass” system for recovering one or more metal salts. The system 300 may be configured to selectively remove different metal salts from a solution based, at least in part, on a pressure to which the solution is exposed when contacted with DME.

The solid 302 may be substantially similar to the solid 202 described above with reference to FIG. 2 and may include one or more metals to be extracted and recovered in the system 300. The solid 302 may be mixed with a leaching solution 306 in a leaching chamber 304. The leaching solution 306 and the leaching chamber 304 may be substantially similar to the leaching solution 206 and the leaching chamber 204 described above with reference to FIG. 2.

As described above with reference to the first salt-containing solution 208, mixing the leaching solution 306 with the solid 302 in the leaching chamber 304 generates a salt-containing solution 308 (e.g., including one or more dissolved metals). The salt-containing solution 308 is mixed with a first DME stream 312 in a first fractional crystallization chamber 310 to form a first aqueous solution 311 including the DME and the salt-containing solution 308. The DME facilitates precipitation of one or more solids (e.g., metal salts) from the first aqueous solution 311 to form a first solid 314 and a first treated solution 313 from which the first solid 314 has been removed.

The first treated solution 313 may be passed through a second fractional crystallization chamber 316 where it is mixed with a second DME stream 318 to form a second aqueous solution 317. The DME of the second DME stream 318 facilitates precipitation of a second solid 320 from the second aqueous solution 317. Remaining portions of the second aqueous solution 317 are removed from the second fractional crystallization chamber 316 as a second treated solution 322.

The second treated solution 322 may be passed through a third fractional crystallization chamber 324 where it is mixed with a third DME stream 326 to form a third aqueous solution 325. The DME of the third DME stream 326 facilitates precipitation of a third solid 328 from the third aqueous solution 325.

Remaining portions of the third aqueous solution 325 are removed from the third fractional crystallization chamber 324 as a third treated solution 330 and passed through an expander 332 to form a reduced pressure third treated solution 334. The reduced pressure third treated solution 334 flows to a solvent recovery chamber 336 where the DME is separated from other portions of the reduced pressure third treated solution 334 to form a low pressure gaseous DME stream 338 and a low pressure treated aqueous solution stream 340. The low pressure treated aqueous solution stream 340 may be recycled in the system 300, such as to the leaching solution 306.

The low pressure gaseous DME stream 338 may be pressurized in a compressor 342 to generate pressurized DME stream 344. The pressurized DME stream 344 may be recycled in the system 300, such as to one or more of the first DME stream 312, the second DME stream 318, and the third DME stream 326.

A pressure in each of the first fractional crystallization chamber 310, the second fractional crystallization chamber 316, and the third fractional crystallization chamber 324 may be different than the pressure in the other of the first fractional crystallization chamber 310, the second fractional crystallization chamber 316, and the third fractional crystallization chamber 324. In some embodiments, the pressure of each subsequent fractional crystallization chamber is less than the pressure of the preceding fractional crystallization chambers. In other words, as the salt-containing solution (e.g., the salt-containing solution 308, the first treated solution 313, the second treated solution 322) passes through the system 300, the pressure of the fractional crystallization chambers decrease. Accordingly, the pressure of the first fractional crystallization chamber 310 is greater than the pressure of the second fractional crystallization chamber 316, which is, in turn, greater than the pressure of the third fractional crystallization chamber 324.

In some embodiments, the different pressures of the first fractional crystallization chamber 310, the second fractional crystallization chamber 316, and the third fractional crystallization chamber 324 facilitate precipitation of the respective first solid 314, second solid 320, and third solid 328 having different compositions. Accordingly, each of the first solid 314, the second solid 320, and the third solid 328 may comprise a different material composition than the others of the first solid 314, the second solid 320, and the third solid 328.

In some embodiments, a temperature of each of the first fractional crystallization chamber 310, the second fractional crystallization chamber 316, and the third fractional crystallization chamber 324 may individually be within a range of from about −30° C. to about 60° C., such as from about −30° C. to about −20° C., from about −20° C. to about −10° C., from about −10° C. to about 0° C., from about 0° C. to about 10° C., from about 10° C. to about 20° C., from about 20° C. to about 30° C., from about 30° C. to about 40° C., from about 40° C. to about 50° C., or from about 50° C. to about 60° C. In some embodiments, a temperature of at least one of first fractional crystallization chamber 310, the second fractional crystallization chamber 316, and the third fractional crystallization chamber 324 is different from the temperature of at least another of the first fractional crystallization chamber 310, the second fractional crystallization chamber 316, and the third fractional crystallization chamber 324. In some embodiments, a temperature of each of the first fractional crystallization chamber 310, the second fractional crystallization chamber 316, and the third fractional crystallization chamber 324 is different from the temperature of the other of the first fractional crystallization chamber 310, the second fractional crystallization chamber 316, and the third fractional crystallization chamber 324.

In some embodiments, adjusting the temperature of the first aqueous solution 311, the second aqueous solution 317, and the third aqueous solution 325 alters the solubility of the dissolved salts in the respective aqueous solutions. Accordingly, adjusting the temperature may facilitate controlling the composition of the each of the first solid 314, the second solid 320, and the third solid 328.

As described above with reference to the fractional crystallization chamber 102 (FIG. 1) and the nucleation scaffold 126 (FIG. 1), each of the first fractional crystallization chamber 310, the second fractional crystallization chamber 316, and the third fractional crystallization chamber 324 may individually include a nucleation scaffold that may be substantially similar to the nucleation scaffold 126. In some embodiments, at least one of first fractional crystallization chamber 310, the second fractional crystallization chamber 316, and the third fractional crystallization chamber 324 includes a nucleation scaffold and at least others of the first fractional crystallization chamber 310, the second fractional crystallization chamber 316, and the third fractional crystallization chamber 324.

In some embodiments, each of the first fractional crystallization chamber 310, the second fractional crystallization chamber 316, and the third fractional crystallization chamber 324 individually comprises a nucleation scaffold configured to facilitate precipitation of a desired solid. In some embodiments, each of the first fractional crystallization chamber 310, the second fractional crystallization chamber 316, and the third fractional crystallization chamber 324 comprises a nucleation scaffold having a different composition or geometry than the others of the first fractional crystallization chamber 310, the second fractional crystallization chamber 316, and the third fractional crystallization chamber 324.

Each of the first DME stream 312, the second DME stream 318, and the third DME stream 326 may individually comprise liquid DME or pressurized gaseous DME. In some embodiments, at least one of the first DME stream 312, the second DME stream 318, and the third DME stream 326 comprises gaseous DME and at least another of the first DME stream 312, the second DME stream 318, and the third DME stream 326 comprises liquid DME.

With continued reference to FIG. 3, in some embodiments, a composition of the solids that precipitate in the respective first fractional crystallization chamber 310, the second fractional crystallization chamber 316, and the third fractional crystallization chamber 324 depends on one or more of the saturation level of the dissolved salts in the respective salt-containing solution 308, the first treated solution 313, and the second treated solution 322; the saturation activity (saturation point under the specific conditions) of the dissolved metal salts; the level of hydration (e.g., the amount of water in the respective first aqueous solution 311, the second aqueous solution 317, and the third aqueous solution 325); and the reaction kinetics of the precipitation process. In some embodiments, low saturation metal salts are precipitated first (e.g., in the first fractional crystallization chamber 310 as the first solid 314), followed by precipitation of increasing saturation metal salts in subsequent fractional crystallization passes. The pressure in each of the first fractional crystallization chamber 310, the second fractional crystallization chamber 316, and the third fractional crystallization chamber 324 determines, at least in part, the concentration of DME (the saturation agent) in the respective first aqueous solution 311, the second aqueous solution 317, and the third aqueous solution 325 according to Henry's law. The pressure in each of the first fractional crystallization chamber 310, the second fractional crystallization chamber 316, and the third fractional crystallization chamber 324 may be tailored to control the precipitation of desired solids in each of the first fractional crystallization chamber 310, the second fractional crystallization chamber 316, and the third fractional crystallization chamber 324.

Although FIG. 3 illustrates three fractional crystallization chambers, the disclosure is not so limited and the number of fractional crystallization chambers may be less than three (e.g., two, one), or more be greater than three (e.g., greater than four, greater than six, greater than eight, etc.). The quantity of fractional crystallization chambers in the system may depend on, for example, the number of fractions (e.g., the number of solids (e.g., the first solid 314, the second solid 320, the third solid 328)) to be obtained from the solid 302 and/or the composition of the leaching solution 306. By way of non-limiting example, in some embodiments, a solid comprising samarium, cobalt, and iron may be leached with the leaching solution 306 to form the salt-containing solution 308 comprising samarium salt, cobalt salt, and iron salt (e.g., each as sulfate salts). In some embodiments, the first solid 314 comprises samarium salt, the second solid 320 comprises cobalt salt, and the third solid 328 comprises iron salt. In other embodiments, the salt-containing solution including dissolved potassium chloride and sodium chloride could be treated in the system 300 to separate the potassium chloride from the sodium chloride. In some such embodiments, the salt-containing solution 308 is passed through a first fractional crystallization chamber at a relatively lower temperature and mixed with DME to precipitate the potassium chloride and form a first treated solution including dissolved sodium chloride. The treated solution is passed through as second fractional crystallization chamber at a temperature higher than the relatively lower temperature of the first fractional crystallization chamber and mixed with DME to precipitate the sodium chloride.

Although FIG. 2 has been described as obtaining the first salt-containing solution 208 to obtain the first solid 214 and treating the solid from each of the fractional crystallization stages to purify the solid and FIG. 3 has been described as obtaining the salt-containing solution 308 and treating the aqueous solution from each of the fractional crystallization chambers to obtain a different solid, the disclosure is not so limited. In some embodiments, the multi-stage fractional crystallization system 200 of FIG. 2 may be combined with the multi-pass fractional crystallization system 300 of FIG. 3 (also referred to as a “multi-pass variable pressure precipitation system”).

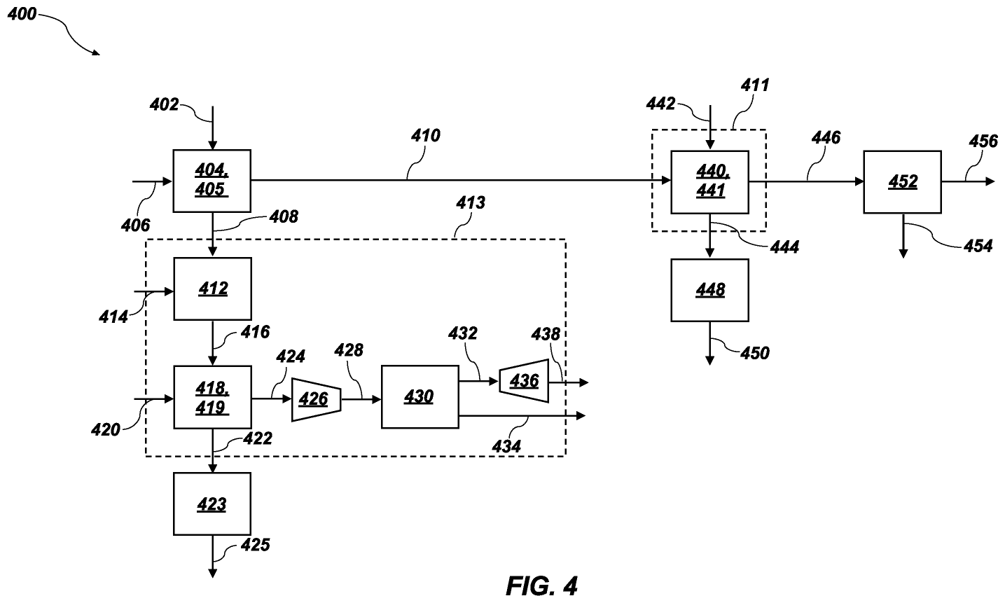

FIG. 4 is a simplified partial process flow diagram illustrating system 400 for recovering one or more salts from a leachate 402, in accordance with embodiments of the disclosure. The system 400 includes a first fractional crystallization chamber 404 configured to mix the leachate 402 with a first DME stream 406. The first fractional crystallization chamber 404 may be substantially similar to the first fractional crystallization chamber 210 (FIG. 2) or the first fractional crystallization chamber 310 (FIG. 3).

The leachate 402 may be substantially similar to the salt-containing solution 104 and may comprise one or more of the materials described above with reference to the salt-containing solution 104. The first DME stream 406 may be substantially similar to one or more of the DME stream 107 (FIG. 1), the first DME stream 212 (FIG. 2), and the first DME stream 312 (FIG. 3).

The leachate 402 is mixed with the first DME stream 406 in the first fractional crystallization chamber 404 to form a first aqueous solution 405, as described above with reference to the first fractional crystallization chamber 210 (FIG. 2) and the first fractional crystallization chamber 310 (FIG. 3). In the first fractional crystallization chamber 404, the DME of the first DME stream 406 mixes with the first aqueous solution 405 and facilitates precipitation of a first solid 408 including one or more desired solids (e.g., metal salts). The first solid 408 may include one or more of the materials described above with reference to the solid stream 113 (FIG. 1), the first solid 214 (FIG. 2), and the first solid 314 (FIG. 3).

Removal of the first solid 408 from the first aqueous solution 405 forms a first treated solution 410, which may be substantially similar to the first treated solution 216 (FIG. 2) or the first treated solution 313 (FIG. 3).

As described in further detail herein, the first treated solution 410 may be further processed, such as by selectively removing additional solids from the first treated solution 410 in one or more passes through one or more additional fractional crystallization chambers, as described above with reference to the system 300 of FIG. 3. In addition, the first solid 408 may be further purified by passing the first solid 408 through one or more additional stages of fractional crystallization chambers, as described above with reference to FIG. 2.

By way of non-limiting example, the first solid 408 may be passed to a first fractional crystallization stage 413, illustrated in dashed box 413. The first fractional crystallization stage 413 is substantially similar to the fractional crystallization stage illustrated in dashed box 205 of FIG. 2. For example, the first fractional crystallization stage 413 includes a first mixing chamber 412 configured to facilitate combining (e.g., mixing) of the first solid 408 with a first solvent 414 to form a first salt-containing solution 416; a second fractional crystallization chamber 418 configured to facilitate combining (e.g., mixing) of the first salt-containing solution 416 with a second DME stream 420 to form a second aqueous solution 419 from which a purified first solid 422 is precipitated to form the purified first solid 422 and a second treated solution 424; a first expander 426 configured to reduce the pressure of the second treated solution 424 and generate a low pressure second treated solution 428; a solvent recovery chamber 430 configured to separated DME from the low pressure second treated solution 428 to generate a gaseous DME stream 432 and a low pressure second treated aqueous solution 434; and a compressor 436 configured to increase the pressure of the gaseous DME stream 432 and form a first pressurized DME stream 438 comprising, for example, liquid DME or high pressure gaseous DME. As described above with reference to FIG. 2 and each of the first pressurized DME stream 230, the second pressurized DME stream 258, the third pressurized DME stream 286, and the fourth pressurized DME stream 209, the first pressurized DME stream 438 may be recycled within the system 400, such as to the first DME stream 406 or the second DME stream 420.

Similarly, as described above with reference to the first solid 214 (FIG. 2), the purified first solid 422 may be further purified in one or more additional fractional crystallization stages, which may be substantially similar to the additional fractional crystallization stage 423. The system 400 may include a desired number of additional fractional crystallization stages to further purify the purified first solid 422, as described above with reference to FIG. 2. For example, the purified first solid 422 may be further purified in one or more additional fractional crystallization stages 423 to form a further purified first solid 425. The one or more additional fractional crystallization stages 423 may be substantially similar to the first fractional crystallization stage 413.

With continued reference to FIG. 4, the first treated solution 410 may be further processed to remove one or more additional solids from the first treated solution 410, as described above with reference to FIG. 3. For example, the first treated solution 410 may be introduced to a fractional crystallization pass system 411 to selectively remove the one or more additional solids from the first treated solution 410.

The fractional crystallization pass system 411 includes a third fractional crystallization chamber 440 configured to mix the first treated solution 410 with a third DME stream 442 and form a third aqueous solution 441. The DME in the third fractional crystallization chamber 440 facilitates separation of one or more solids from the third aqueous solution 441 to form a second solid 444 and a second treated solution 446.

The second solid 444 may be further processed in, for example, one or more additional fractional crystallization stages 448, to form a purified second solid 450. The one or more additional fractional crystallization stages 448 may individually be substantially similar to the first fractional crystallization stage 413 and may include, for example, a combining chamber (e.g., a mixing chamber) configured to mix the second solid 444 with a solvent (e.g., water, substantially similar to the first solvent 414) to form a second salt-containing solution; a fourth fractional crystallization chamber configured to mix a DME stream (e.g., substantially similar to the first DME stream 406 or the second DME stream 420) with the second salt-containing solution to form an aqueous solution from which the purified second solid 450 and a liquid are formed; and an expander, agent recovery chamber, and compressor to separate DME from the remaining portions of the aqueous solution and regenerate the solvent and re-pressurize the DME stream for reuse in the system 400.

The purified second solid 450 may be passed through additional fractional crystallization stages, substantially similar to the first fractional crystallization stage 413 to further purify the purified second solid 450.

A composition of the purified second solid 450 may be different than the composition of the purified first solid 422 and the further purified first solid 425. In some embodiments, the purified second solid 450 comprises a different metal salt than the purified first solid 422 and the further purified first solid 425. In some embodiments, one of the purified second solid 450 and the further purified first solid 425 comprises one of at least one transition metal salt and at least one rare earth element salt and the other of the purified second solid 450 and the further purified first solid 425 comprises the other of the at least one transition metal salt and at least one rare earth element salt.

With continued reference to FIG. 4, in some embodiments, the second treated solution 446 may be further processed to remove one or more additional materials from the second treated solution 446. For example, the second treated solution 446 may be introduced to one or more additional fractional crystallization pass systems 452, each individually including a fractional crystallization chamber configured to mix the second treated solution 446 (or subsequently processed liquid) with an additional DME stream to form an additional solid 454 and an additional treated solution 456.

In some embodiments, the additional solid 454 comprises a different material composition than the purified first solid 422 and the purified second solid 450. By way of non-limiting example, in some embodiments, the additional solid 454 comprises a different metal salt than the purified first solid 422 and the purified second solid 450.

The additional solid 454 may be passed through one or more additional fractional crystallization stages, each substantially similar to the additional fractional crystallization stage 423 to further purify the additional solid 454. Similarly, the additional treated solution 456 may be further processed to remove one or more additional materials from the additional liquid by passing the additional treated solution 456 through an additional fractional crystallization pass system substantially similar to the fractional crystallization pass system 411 to separate one or more additional solids from the additional treated solution 456.

Accordingly, the system 400 may be configured to selectively precipitate one or more solids (e.g., metal salts) each comprising a different material composition from a leachate 402 in a one or more fractional crystallization pass systems (e.g., the first fractional crystallization pass system 411, the additional fractional crystallization pass system 452). The solids formed in the fractional crystallization pass systems (e.g., the first solid 408, the second solid 444, the additional solid 454) may individually be purified by individually passing the solids through one or more fractional crystallization stages (e.g., the first fractional crystallization stage 413, the one or more additional fractional crystallization stages 423, the one or more additional fractional crystallization stages 448) to obtain further purified solids (e.g., the respective purified first solid 422, the further purified first solid 425, and the purified additional solid 454).

Although the solids 202, 302 (FIG. 2, FIG. 3) have been described and illustrated as being dissolved in the respective leaching chambers 204, 304 (FIG. 2, FIG. 3) with only the respective leaching solutions 206, 306 (FIG. 2, FIG. 3) to form the respective first salt-containing solution 208 (FIG. 2) and the salt-containing solution 308 (FIG. 3), the disclosure is not so limited. In some embodiments, the leaching solutions 206, 306 may be mixed with DME.

FIG. 5 is a simplified partial process flow diagram illustrating a system 500 for leaching one or more solid materials from a solid 512, in accordance with embodiments of the disclosure. The system 500 includes a mixing chamber 502 in which a DME stream 504 is mixed with a leaching solution 506. The leaching solution 506 may be substantially similar to the leaching solution 206 (FIG. 2) described above. The DME stream 504 may be substantially similar to the DME streams (e.g., the DME stream 107, the first DME stream 212, the second DME stream 238, the third DME stream 266, the fourth DME stream 294, the first DME stream 312, the second DME stream 318, the third DME stream 326, the first DME stream 406, the second DME stream 420, the third DME stream 442) previously described.

Combining (e.g., mixing) the DME stream 504 with the leaching solution 506 in the mixing chamber 502 forms a DME-containing leaching solution 508 that is introduced to a leaching chamber 510 where the solid 512 is contacted by the DME-containing leaching solution 508 to form a DME-containing salt-containing solution 514. The DME-containing salt-containing solution 514 may be passed through an expander 516 to reduce a pressure of the DME-containing salt-containing solution 514 and form a low pressure DME-containing salt-containing solution 518.

The low pressure DME-containing salt-containing solution 518 enters a solvent recovery chamber 520 (substantially similar to the solvent recovery chamber 110 (FIG. 1)) wherein DME is separated from the low pressure DME-containing salt-containing solution 518 to form a low pressure gaseous DME stream 522 and a low pressure treated solution 524. The low pressure gaseous DME stream 522 is passed through a compressor 526 to form a high pressure DME stream 528. The high pressure DME stream 528 may be recycled to, for example, the DME stream 504. The low pressure treated solution 524 may be introduced to any of the systems 200, 300, 400 (e.g., such as the leaching solution 206 (FIG. 2), the leaching solution 306 (FIG. 3), or the leachate 402 (FIG. 4)).

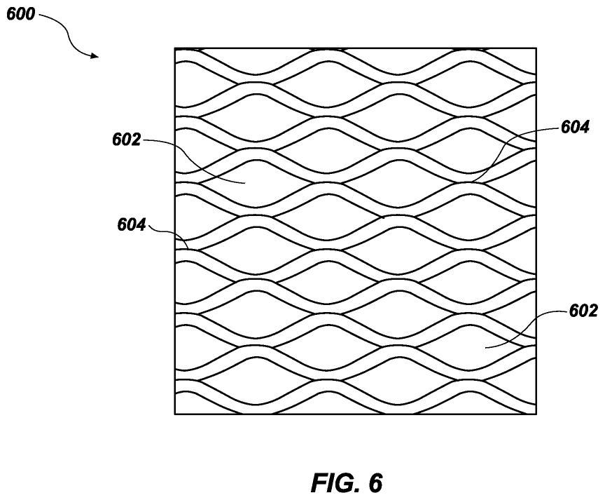

As described above, each of the systems 100, 200, 300, 400, 500 may include one or more nucleation scaffolds, such as within the fractional crystallization chambers thereof. FIG. 6 is a simplified partial perspective view illustrating a nucleation scaffold 600, in accordance with embodiments of the disclosure. The nucleation scaffold 600 may include, for example, a plurality of perforations 602 defined by sidewalls 604. The orientation of the sidewalls 604 may define a shape of the perforations 602. In some embodiments, the perforations 602 exhibit a diamond shape. In other embodiments, the perforations 602 exhibit a circular shape, an elliptical shape, a square shape, a rectangular shape, or a triangular shape.

The nucleation scaffold 600 may be formed of and include a metal, such as, for example, one or more of stainless steel (e.g., stainless steel mesh), another metal, a metal oxide, a polymer material, a ceramic material, glass wool, a plastic material, wood, a composite material, rock, sand, activated carbon, charcoal, string, fiber, biomass, biofiber, or paper. In some embodiments, the nucleation scaffold 600 comprises stainless steel mesh, such as 400 mesh stainless steel.

In some embodiments, one or more of sparging (e.g., with the DME), the location of sparging, the flowrate of sparging, the bubble size induced by sparging may be tuned to facilitate formation of the respective aqueous phase and separation of the solids from the aqueous phase in the fractional crystallization chambers of each of the systems 100, 200, 300, 400, 500. In some embodiments, the DME stream introduced into one or more of the fractional crystallization chambers (e.g., the fractional crystallization chamber 102 (FIG. 1), the first fractional crystallization chamber 210 (FIG. 2), the second fractional crystallization chamber 240 (FIG. 2), the third fractional crystallization chamber 268 (FIG. 2), the fourth fractional crystallization chamber 292 (FIG. 2), the first fractional crystallization chamber 310 (FIG. 3), the second fractional crystallization chamber 316 (FIG. 3), the third fractional crystallization chamber 324 (FIG. 3), the first fractional crystallization chamber 404 (FIG. 4), the second fractional crystallization chamber 418 (FIG. 4), and the third fractional crystallization chamber 440 (FIG. 4)) may be provided thereto at a desired flowrate and pressure. In addition, the DME streams may be provided through, for example, a sparger configured to generate turbulence and/or bubbles having a desired size in the respective fractional crystallization chamber. By way of non-limiting example, the size of the bubbles may be tuned by perforations through which the DME stream is provided to the fractional crystallization chamber.

In some embodiments, one or more of the fractional crystallization chambers (e.g., the fractional crystallization chamber 102 (FIG. 1), the first fractional crystallization chamber 210 (FIG. 2), the second fractional crystallization chamber 240 (FIG. 2), the third fractional crystallization chamber 268 (FIG. 2), the fourth fractional crystallization chamber 292 (FIG. 2), the first fractional crystallization chamber 310 (FIG. 3), the second fractional crystallization chamber 316 (FIG. 3), the third fractional crystallization chamber 324 (FIG. 3), the first fractional crystallization chamber 404 (FIG. 4), the second fractional crystallization chamber 418 (FIG. 4), and the third fractional crystallization chamber 440 (FIG. 4)) may be sonicated to facilitate combining (e.g., mixing) of the DME stream into the aqueous solution.

FIG. 7 is a simplified partial process flow diagram illustrating a system 700 including a fractional crystallization chamber 702 configured to facilitate an aqueous two-phase system. The fractional crystallization chamber 702 may replace any of the fractional crystallization chambers (e.g., the fractional crystallization chamber 102 (FIG. 1), the first fractional crystallization chamber 210 (FIG. 2), the second fractional crystallization chamber 240 (FIG. 2), the third fractional crystallization chamber 268 (FIG. 2), the fourth fractional crystallization chamber 292 (FIG. 2), the first fractional crystallization chamber 310 (FIG. 3), the second fractional crystallization chamber 316 (FIG. 3), the third fractional crystallization chamber 324 (FIG. 3), the first fractional crystallization chamber 404 (FIG. 4), the second fractional crystallization chamber 418 (FIG. 4), and the third fractional crystallization chamber 440 (FIG. 4)).

A salt-containing solution 704 is introduced into the fractional crystallization chamber 702, where it is mixed with DME from a DME stream 706 to form a two-phase aqueous solution 703. The fractional crystallization chamber 702 includes a first outlet 708 vertically above a second outlet 710. The first outlet 708 is configured to remove a low-density aqueous phase from the two-phase aqueous solution 703 and the second outlet 710 is configured to remove a high-density aqueous phase from the two-phase aqueous solution 703.

The low-density aqueous phase removed through the first outlet 708 may comprise more DME than the high-density aqueous phase removed through the second outlet 710; and the high-density aqueous phase may include a greater concentration of dissolved salts than the low-density aqueous phase. DME may individually be recovered from each of the low-density aqueous phase and the high-density aqueous phase, as described above with reference to, for example, recovery of DME from the treated solution 116 (FIG. 1), the first treated solution 216 (FIG. 2), the second treated solution 244 (FIG. 2), the third treated solution 272 (FIG. 2), the fourth treated solution 296 (FIG. 2), the third treated solution 330 (FIG. 3), and the second treated solution 424 (FIG. 4).

The remaining liquid of the low-density aqueous phase after separation of the DME may be used in the system, such as by mixing with a leachate, mixing with a leaching fluid, or introducing into a fractional crystallization chamber (e.g., the fractional crystallization chamber 102 (FIG. 1), the first fractional crystallization chamber 210 (FIG. 2), the second fractional crystallization chamber 240 (FIG. 2), the third fractional crystallization chamber 268 (FIG. 2), the fourth fractional crystallization chamber 292 (FIG. 2), the first fractional crystallization chamber 310 (FIG. 3), the second fractional crystallization chamber 316 (FIG. 3), the third fractional crystallization chamber 324 (FIG. 3), the first fractional crystallization chamber 404 (FIG. 4), the second fractional crystallization chamber 418 (FIG. 4), and the third fractional crystallization chamber 440 (FIG. 4)).

The remaining fluid of the high-density aqueous phase after separation of the DME may be further processed, such as by removing the dissolved salts therefrom, as previously described with respect to the salt-containing solutions.

In some embodiments, a DME stream 712 may be removed from the fractional crystallization chamber and recycled. A solid 714 may be removed from the fractional crystallization chamber 702, such as through an additional outlet.

### EXAMPLES

### Example 1

A reaction system was used to recover dissolved solids from various solutions. The reaction system included a glass reaction vessel into which the solutions were mixed with gaseous DME. The glass reaction vessel was a dual chamber tube, the inner tube including the solution and the DME, and the outer tube defining a volume (e.g., an annulus) between the inner tube and the outer tube for receiving a water bath to control the temperature of the solution and DME in the inner tube. The glass reaction vessel was about 40 cm long. The inner tube had an outer diameter of about 31.7 mm and a wall thickness of about 4 mm. The outer tube had a 50 mm diameter and a wall thickness of about 5 mm. A 316 stainless steel 400 mesh nucleation scaffold was disposed in the inner tube.

Gaseous DME was used as a saturation agent to influence the solubility limits of the solutions. During the recovery of dissolved solids from each of the solutions, DME was recirculated from the headspace of glass reaction vessel through the solution in the inner tube to sparge the solution in the inner tube. Recirculation and sample introduction were accomplished through use of a gear pump (Cole Parmer 115V 60 Hz console drive, EW 35215-30, fitted with a Cole Parmer Micro pump head, EW-07001-40).

During the recovery of each of the solutions, the inner tube was provided with a volume of the solution within a range of from about 100 mL to about 200 mL. Gaseous DME was mixed with the solution in the inner tube. The temperature of the inner tube was maintained within a range of from about 20° C. to about 31° C. with the water bath, depending on the particular experiment. The pressure of the inner tube was maintained at about 528.8 kPa (about 76.7 psi; about 62.0 psig). After about 15 minutes of circulation of the DME through the inner tube, the solution became turbid, followed by crystal growth on the nucleation scaffold. During crystal growth, the solution in the inner tube began to partition into an enriched phase at the bottom of the inner tube and a depleted phase above the enriched phase. The precipitated crystals were recovered from the nucleation scaffold.

In one experiment, the initial solution comprised a mixed metal sulfate leachate with initial metal concentrations of 42.857 g/L Co, 20.128 g/L Sm, and 3.215 g/L Fe. The solution was introduced to the reaction chamber via a gear pump and water was recirculated in the outer chamber at 18° C. DME gas was introduced to the reaction chamber and purged 5 times to remove partial pressures of atmospheric gas. After purging, the reaction chamber was pressurized with DME gas to 528.8 kPa (about 76.7 psi; about 62.0 psig), with the gear pump recirculating gas from the chamber headspace through the aqueous solution via a Teflon tube. As DME dissolved into the system, the volume of the aqueous solution expanded by about 25%, and the solution became visibly turbid after about 15 minutes of recirculation of the gaseous DME. Several minutes after the appearance of turbidity, visible crystal growth began on the nucleation scaffold. As crystal growth began, a partitioning of the aqueous solution into an enriched phase at the bottom of the reaction chamber, and a depleted phase above the enriched phase was induced by chamber geometry and gas sparging.

In a different experiment, metal salts were recovered from a leachate comprising dissolved samarium and dissolved cobalt at each of 20° C. and 31° C. In another experiment, the solution comprised a leachate of a neodymium-iron-boron magnet, the leachate including dissolved neodymium, iron, and boron at 31° C. The leachate further included praseodymium, samarium, and dysprosium. The separation efficiency of various metals was quantified as a separation factor, α, defined as the ratio of a metal in a solid product relative to that in the original leachate (aqueous phase), as shown in Equation (1) below for the separation factor of cobalt relative to samarium:

α_{Co/Sm}=(mass %Co(s)/mass %Co(aq))/(mass %Sm(s)/mass %Sm(aq)); Equation 1,

wherein mass % Co(s) is the mass percent of cobalt in the final solid; mass % Co(aq) is the mass percent of cobalt in the initial aqueous solution; mass % Sm(s) is the mass percent of samarium in the final solid; and mass % Sm(aq) is the mass percent of samarium in the initial aqueous solution. A larger separation factor is an indication of the amount of separation (e.g., a purity) of one material or component relative to one or more other materials or components. Table I below illustrates the separation factors for different leachates at various temperatures.

TABLE I

| Leachate | Temperature | Product | Separation | α |
|---|---|---|---|---|
| Sm—Co—Fe | 20° C. | Co-rich | α_{Co/Sm} | 95.3 |
| | | | α_{Fe+Co/Sm} | 86.9 |
| | | | α_{Fe/Co} | 1.19 |
| | 31° C. | Sm-rich | α_{Sm/Fe+Co} | 379 |
| | | | α_{Sm/Co} | 704 |
| | | | α_{Fe/Co} | 13.2 |
| Nd—Fe—B | 31° C. | Ln-rich | α_{Ln/Fe+Co} | 48.5 |
| | | | α_{Fe/Co} | 1.46 |
| | | | α_{Nd/Σ} | 3.17 |
| | | | α_{Pr/Σ} | 2.07 |
| | | | α_{Sm/Σ} | 4.34 |
| | | | α_{Dy/Σ} | 0.89 |

In Table I above, α_{Ln/(Fe+Co)} represents the separation factor of lanthanides (e.g., neodymium, praseodymium, samarium, and dysprosium) relative to the sum of iron and cobalt; and Σ represents the sum of components in the initial solution other than the component for which the particular separation factor is being determined (e.g., α_{Nd/Σ} is the separation factor of neodymium relative to the sum of cobalt, iron, praseodymium, samarium, and dysprosium).

The solids recovered from the nucleation scaffold in each experiment appeared to feature enhanced purity.

Inductively coupled plasma optical emission spectrometry (ICP-OES) of the Sm—Co—Fe leachate measured 69.94% Co, 4.78% Fe, and 24.60% Sm by mass. Solids recovered from the nucleation scaffold were acid-digested and analyzed with ICP-OES, with metal composition measured to be 0.29% Co, 0.28% Fe, and 99.43% Sm by mass.

Accordingly, fractional crystallization appears viable as a way to remove multiple components from a leachate stream as individual outputs. With reference to Table I, a small shift in temperature of about 11° C. allowed different products, e.g., different metal sulfates, to be precipitated.

### Example 2

Hard water including calcium sulfate (CaSO₄) (also referred to as “gypsum”) and silicate salts was exposed to pressurized DME to precipitate the calcium sulfate and the silicate salts. The pressurized DME was provided at about 506. 6 kPa (about 73.5 psi). The DME was recovered at lower pressure (e.g., about 202.7 kPa) and provided to a compressor for reuse. The compressor pressurized the DME for reuse. About 97.7 weight percent of the gypsum and about 95 weight percent of the silicates were removed from the hard water.

### Example 3

A solution comprising dissolved cobalt, iron, and samarium was contacted with pressurized DME in a chamber. The chamber included a stainless-steel nucleation scaffold. Cobalt and samarium sulfate were independently recovered as precipitates. The concentration of the cobalt in the solution decreased by about 95 percent and the concentration of the samarium in the solid precipitate decreased by about 98 percent. The cobalt precipitated as cobalt sulfate and the samarium precipitated as samarium sulfate. The purity of the cobalt sulfate was greater than 91 percent and the purity of the samarium sulfate was greater than 99 percent.

### Example 4

A leachate comprising dissolved samarium, cobalt, and iron from a Sm—Co magnet was provided to a first fractional crystallization chamber at a first temperature and pressure and mixed with a first DME stream to form a first aqueous solution. A first solid was precipitated from the first aqueous solution to form a first treated solution. The first solid comprised cobalt and iron and the first treated solution included samarium.

The first solid was mixed with a solvent comprising water and mixed with a second DME stream in a second fractional crystallization chamber to form a second aqueous stream. A second solid was separated from the second aqueous stream to form a second treated solution. The second solid comprises a greater purity of the cobalt and iron.

The first treated solution was mixed with a third DME stream in a third fractional crystallization chamber at a second temperature and pressure to form a third aqueous solution. A third solid comprising samarium was separated from the third aqueous solution in the third fractional crystallization chamber to form a third treated solution. The third treated solution was substantially free of samarium.

### Example 5

A leachate comprising dissolved neodymium, praseodymium, samarium, dysprosium, iron, and boron from an Nd-Fe—B magnet was provided to a first fractional crystallization chamber at a first temperature and pressure and mixed with a first DME stream for form a first aqueous solution. A first solid was precipitated from the first aqueous solution to form a first treated solution. The first solid comprised cobalt and iron and the first treated solution included neodymium, praseodymium, samarium, and dysprosium.

The first solid was mixed with a solvent comprising water and mixed with a second DME stream in a second fractional crystallization chamber to form a second aqueous stream. A second solid was separated from the second aqueous stream to form a second treated solution. The second solid comprises a greater purity of the cobalt and iron.

The first treated solution was mixed with a third DME stream in a third fractional crystallization chamber at a second temperature and pressure to form a third aqueous solution. A third solid comprising neodymium, praseodymium, samarium, and dysprosium was separated from the third aqueous solution in the third fractional crystallization chamber to form a third treated solution. The third treated solution was substantially free of each of neodymium, praseodymium, samarium, and dysprosium.

Additional non-limiting example embodiments of the disclosure are set forth below.
Embodiment 1: A method of removing one or more solids from an aqueous solution, the method comprising: introducing, into a first fractional crystallization chamber, dimethyl ether and a salt-containing solution comprising one or more dissolved salts to form an aqueous solution; and precipitating a first solid from the aqueous solution.
Embodiment 2: The method of Embodiment 1, further comprising dissolving the first solid in a solvent to form an additional aqueous solution.
Embodiment 3: The method of Embodiment 2, further comprising: introducing dimethyl ether into the additional aqueous solution; and precipitating a second solid from the additional aqueous solution, the second solid having a greater purity than the first solid.
Embodiment 4: The method of any one of Embodiments 1 through 3, wherein forming an aqueous solution comprises introducing dimethyl ether into the aqueous solution at a pressure greater than about 101.3 kPa.
Embodiment 5: The method of any one of Embodiments 1 through 4, wherein precipitating a first solid from the aqueous solution comprises forming the first solid and a treated solution, further comprising combining the treated solution with additional dimethyl ether in a second fractional crystallization chamber.
Embodiment 6: The method of Embodiment 5, wherein combining the treated solution with additional dimethyl ether in a second fractional crystallization chamber comprises combining the treated solution with the additional dimethyl ether in a second fractional crystallization chamber having a different pressure than the first fractional crystallization chamber.
Embodiment 7: The method of Embodiment 5 or Embodiment 6, wherein combining the treated solution with additional dimethyl ether in a second fractional crystallization chamber comprises combining the treated solution with the additional dimethyl ether in a second fractional crystallization chamber having a different temperature than the first fractional crystallization chamber.
Embodiment 8: The method of any one of Embodiments 5 through 7, further comprising precipitating a second solid in the second fractional crystallization chamber, the second solid comprising a different material composition than the first solid.
Embodiment 9: The method of Embodiment 8, further comprising combining the second solid with a solvent and precipitating a purified second solid in a third fractional crystallization chamber, the purified second solid having a greater purity than the second solid.
Embodiment 10: The method of any one of Embodiments 1 through 9, further comprising providing a nucleation scaffold in the first fractional crystallization chamber.
Embodiment 11: The method of any one of Embodiments 1 through 10, wherein forming an aqueous solution comprises forming two distinct aqueous phases prior to precipitating the first solid.
Embodiment 12: The system of Embodiment 11, further comprising separating the two distinct aqueous phases from one another prior to precipitating the first solid.
Embodiment 13: The system of any one of Embodiments 1 through 12, further comprising mixing aqueous dimethyl ether with a mixed solid to form the salt-containing solution.
Embodiment 14: The system of any one of Embodiments 1 through 13, wherein forming an aqueous solution comprises forming an aqueous solution comprising one or more rare earth elements, one or more transition metals, or both.
Embodiment 15: A system for separating one or more solids from a solution including the one or more dissolved salts, the system comprising: a fractional crystallization chamber comprising an inlet and an outlet, the inlet configured to receive an aqueous solution comprising one or more dissolved salts; a dimethyl ether source configured to provide dimethyl ether into the fractional crystallization chamber; an expander in fluid communication with the fractional crystallization chamber and configured to reduce a pressure of a treated solution from the fractional crystallization chamber; a dimethyl ether recovery chamber in fluid communication with the expander and configured to separate the dimethyl ether from the treated solution and form a gaseous dimethyl ether stream; and a compressor to compress the gaseous dimethyl ether stream and provide a high pressure dimethyl ether stream to the dimethyl ether source.
Embodiment 16: The system of Embodiment 15, wherein the fractional crystallization chamber is configured to recover a precipitated solid.
Embodiment 17: The system of Embodiment 15 or Embodiment 16, wherein the outlet of the fractional crystallization chamber comprises a first outlet configured to remove a first aqueous phase from the fractional crystallization chamber and a second outlet configured to remove a second aqueous phase from the fractional crystallization chamber.
Embodiment 18: The system of any one of Embodiments 15 through 17, further comprising a nucleation scaffold in the fractional crystallization chamber configured to facilitate precipitation of one of the one or more dissolved solids.
Embodiment 19: The system of Embodiment 18, wherein the nucleation scaffold comprises seed crystals of the one of the one or more dissolved solids.
Embodiment 20: The system of any one of Embodiments 15 through 19, further comprising an additional fractional crystallization chamber configured to receive precipitated solid from the fractional crystallization chamber and further purify the precipitated solid.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

1. A method of removing one or more solutes from an aqueous solution, the method comprising:
introducing, into a first fractional crystallization chamber, dimethyl ether and a salt-containing solution comprising one or more dissolved salts to form an aqueous solution; and
precipitating a first solid from the aqueous solution.

2. The method of claim 1, further comprising dissolving the first solid in a solvent to form an additional aqueous solution.

3. The method of claim 2, further comprising:
introducing dimethyl ether into the additional aqueous solution; and
precipitating a second solid from the additional aqueous solution, the second solid having a greater purity than the first solid.

4. The method of claim 1, wherein forming an aqueous solution comprises introducing dimethyl ether into the aqueous solution at a pressure greater than about 101.3 kPa.

5. The method of claim 1, wherein precipitating a first solid from the aqueous solution comprises forming the first solid and a treated solution, further comprising combining the treated solution with additional dimethyl ether in a second fractional crystallization chamber.

6. The method of claim 5, wherein combining the treated solution with additional dimethyl ether in a second fractional crystallization chamber comprises combining the treated solution with the additional dimethyl ether in a second fractional crystallization chamber having a different pressure than the first fractional crystallization chamber.

7. The method of claim 5, wherein combining the treated solution with additional dimethyl ether in a second fractional crystallization chamber comprises combining the treated solution with the additional dimethyl ether in a second fractional crystallization chamber having a different temperature than the first fractional crystallization chamber.

8. The method of claim 5, further comprising precipitating a second solid in the second fractional crystallization chamber, the second solid comprising a different material composition than the first solid.

9. The method of claim 8, further comprising combining the second solid with a solvent and precipitating a purified second solid in a third fractional crystallization chamber, the purified second solid having a greater purity than the second solid.

10. The method of claim 1, further comprising providing a nucleation scaffold in the first fractional crystallization chamber.

11. The method of claim 1, wherein forming an aqueous solution comprises forming two distinct aqueous phases prior to precipitating the first solid.

12. The method of claim 11, further comprising separating the two distinct aqueous phases from one another prior to precipitating the first solid.

13. The method of claim 1, further comprising mixing an aqueous solution with dimethyl ether to leach a solid to form the salt-containing solution.

14. The method of claim 1, wherein forming an aqueous solution comprises forming an aqueous solution comprising one or more rare earth elements, one or more transition metals, or both.

15. A system for separating one or more solutes from a solution including one or more dissolved salts, the system comprising:
a fractional crystallization chamber comprising an inlet and an outlet, the inlet configured to receive an aqueous solution comprising one or more dissolved salts;
a dimethyl ether source configured to provide dimethyl ether into the fractional crystallization chamber;
an expander in fluid communication with the fractional crystallization chamber and configured to reduce a pressure of a treated solution from the fractional crystallization chamber;
a dimethyl ether recovery chamber in fluid communication with the expander and configured to separate the dimethyl ether from the treated solution and form a gaseous dimethyl ether stream; and
a compressor to compress the gaseous dimethyl ether stream and provide a high pressure dimethyl ether stream to the dimethyl ether source.

16. The system of claim 15, wherein the fractional crystallization chamber is configured to recover a precipitated solid.

17. The system of claim 15, wherein the outlet of the fractional crystallization chamber comprises a first outlet configured to remove a first aqueous phase from the fractional crystallization chamber and a second outlet configured to remove a second aqueous phase from the fractional crystallization chamber.

18. The system of claim 15, further comprising a nucleation scaffold in the fractional crystallization chamber configured to facilitate precipitation of one of the one or more dissolved solids.

19. The system of claim 18, wherein the nucleation scaffold comprises seed crystals of the one of the one or more dissolved solids.

20. The system of claim 15, further comprising an additional fractional crystallization chamber configured to receive precipitated solid from the fractional crystallization chamber and further purify the precipitated solid.
